(19) United States
(12) Patent Application Publication
(10) Pub. No.: US 2017/0068270 A1
(43) Pub. Date: Mar. 9, 2017

(54) IMPROVED SUPPORT FOR A PORTABLE COMPUTER

(71) Applicant: Peter Johann Kielland, Ottawa (CA)

(72) Inventor: Peter Johann Kielland, Ottawa (CA)

(21) Appl. No.: 15/307,875

(22) PCT Filed: Apr. 30, 2015
(86) PCT No.: PCT/CA2015/000276

§ 371 Date: Oct. 31, 2016

(30) Foreign Application Priority Data
May 1, 2015 (CA) 2850596
Jun. 3, 2015 (CA) 2853435

(51) Int. Cl. G06F 1/16; A45F 3/14; A45F 5/00

(52) U.S. Cl. CPC G06F 1/163; A45F 5/00; A45F 3/14; A45F 2003/142

(57) ABSTRACT

A computer support provides improved access to the virtual keyboard of a tablet computer by routing the neck strap over the outer periphery of the computer. Strain on the neck of a wearer is relieved by back straps that exert a downward force on the neck strap. Similar support is provided by a garment in the form of a vest to which the neck straps are anchored. A protective receiving case for the computer can be provided and optionally used to convert the device into an attractive shoulderbag accessory having a fashionable appearance.

### FIELD OF THE INVENTION

This invention relates to a device for supporting portable computers, including touchscreen tablets, netbooks, traditional portable computers, book readers, video presenters and other electronic articles that provide a display in front of a user, collectively identified herein as “computers”. The invention addresses means to facilitate the positioning and manipulation of such computer devices as they are being “worn” by a user. It also addresses a computer support that allows for the ready presentation of such a computer on a support surface before a user, enhanced by additional peripherals and accessories.

### BACKGROUND TO THE INVENTION

Numerous support devices have been proposed to allow a user to carry a computer in a ready-to-use position in front of the user's body. A variety of arrangements proposed by the same inventor as herein for carrying a portable computer, making it essentially “wearable”, are described in PCT application CA/2012/000342, the contents of which are adopted herein by reference.

The utility of a computer support system of the type addressed is closely dependent upon the convenience with which it may be deployed and stored by a user. Additionally, the comfort experienced by a user when operating or storing a computer carried in a computer support device is an important consideration for users. This invention addresses improvements to both the utility and comfort of a computer support, as well as other useful arrangements for such a device. In particular, the inventions described herein addresses such issues as:

1) the location of the harness cords with respect to the user's hands as they affect accessing the computer while it is being worn in its mobile operative mode;
2) the effect on the neck strap on the neck of a user when the device is worn for extended periods of time;
3) the provision of a carrying bag that is easily transported with the computer,
4) the provision of a sun shade for use either when the computer support is worn or on a table support that is easily transported with the computer, and
5) integration of the computer support and computer human apparel.

The invention in its general form will first be described, and then its implementation in terms of specific embodiments will be detailed with reference to the drawings following hereafter. These embodiments are intended to demonstrate the principle of the invention, and the manner of its implementation. The invention in its broadest and more specific forms will then be further described, and defined, in each of the individual claims which conclude this Specification.

### SUMMARY OF THE INVENTION

According to one aspect of the invention a computer support for attachment to a portable computer to be used by a user comprises:

a) a body support member such as a neck or shoulder strap or cord (hereafter variously a “cord(s)”, “neck cord(s)”, “neck strap”, “support strap”) by which the weight of the computer may be carried by the upper body of the user, and
b) a body propping member for positioning the computer outwardly from the torso of the user that includes two movable arms with computer connections for connecting with the computer when present and outer deployable arm ends that are joined by a bridge to form a U-shaped propping member or “swingarm”,
wherein such arms are deployable from storage positions along the sides of and coplanar with the computer when present to an operating position whereat the respective deployable ends of the arms are positioned for being supported by the torso of the user, at least one of such arms being disengageably fixable at the deployed position to allow locking of the U-shaped propping member in place, and
the body support member comprises two cord portions that, when the U-shaped propping member is deployed, carry at least a portion of the weight of said computer support and computer when present through engagement points located proximate to the outer two corners of a computer when present.

The body support member may be anchored to the computer or computer support at the engagement points. Or it may be anchored at locations elsewhere on the computer or computer support with the weight of the computer being distributed between the anchor points and the engagement points. In this latter case the connection to the engagement points may be a sliding connection and may also be a disengageable connection.

The arms may connected directly to the computer as through clamps that engage the edge of the computer or through openings into the side edges of the computer which receive fasteners. Or the arms may be connected to a backing plate that extends between the two arms to which the computer is mounted. Collectively such structures howsoever arranged comprise the computer connections for connecting the arms to a computer when present.

Optionally and preferably the body support member, when present, comprises adjustment means to permit the user to raise or lower the vertical location of the computer when carried by said user. The body support member may be detached from the computer support when the computer is in table-top use and in other convenient circumstances.

An advantage of routing the neck strap or cord through positions which are located proximate to the outer two corners of a computer when present is to clear the sides of the computer of the interfering presence of such cords descending from the neck or shoulders of a user when the computer support is in its deployed mode. This provides improved manual access to the keyboard.

Another advantage of engagement points as described is that when the computer is placed in a stored position within the frame of the U-shaped propping member it may be rotated to lie in a vertical plane against the torso of the user with the engagement points on the lower end of the computer. So positioned the lengths of the supporting neck cords need not necessarily be adjusted. The computer in its computer support can hang comfortably against the front portion of the body of the user ready to be deployed without having to adjust the length of the neck straps during redeployment.

The engagement points may be located on the outer corners of the computer or on outer corners of the backing plate, or extensions thereto, that are positioned proximate or nearly adjacent to the outer corners of the computer along or adjacent to the edge of the computer or backing plate that is remote from the torso of a user. The neck cords may terminate and be anchored at such engagement points; or they may be anchored elsewhere, having a sliding or removable relationship with the engagement points.

Whether the engagement points are located either proximate to the outer corners of a computer when present or on the backing plate or an extension thereto, each neck cord may terminate and be anchored at such engagement points. Alternately the engagement points may be provided with a “fairlead” type of connector or equivalent that removably captures the cord while permitting the cord to slide through such connector. In the latter case the ends of the neck cords may terminate and be anchored at anchor points on the backing plate or side arms. As a further option a travelling hook on each of the cords may be disengageably fastened to a hook anchor at the respective engagement points.

Howsoever the neck cords are connected to the engagement points such cords carry at least a portion of the weight of said computer through engagement points located proximate to the outer two corners of a computer when present. It is not essential that the cords terminate and be anchored at the engagement points. The object is for such cords to carry at least a portion of the weight of the computer and computer support combination, stabilizing it for use with the cords positioned to maximize user access to a keyboard on the computer.

With the cords so positioned there will be a greater tendency for the bridge of the U-shaped propping member to slide down on the torso of a user. While this bridge may have a frictional engaging surface to resist this tendency, the bridge can be solidly positioned in place by employing a waist strap, preferably elasticized, that passes around the back of the user. The two ends of such waist strap are then removeably connected to the U-shaped propping member with sliding waist strap engagements along the respective sidearms. This connection location may be adjusted by sliding the ends of the waist strap along the sidearms to comfortably position the computer and its support against the torso of the user.

By employing a hook and loop fastener of the Velcro™ type at the ends of the waist strap, a complimentary coupling element positioned along the waist band of clothing of a user may be used to fasten such ends in “parked” locations when not coupled for stabilizing the computer.

The waist strap need not be a unitary element but may be subdivided into components that connect with a garment being worn by a user. When the computer is deployed this waist strap engagement point can be at the junction where the sidearms meet with the connecting bridge.

Not only will such a waist strap stabilize the computer support when deployed but, being elasticized, can be slid along the sidearms to a location which is more central within the sidearms when the computer is stored flat against the torso of the user. This provides a more nearly balanced retention force by which the computer and computer support are being pulled against the user's torso by the elasticized waist strap.

To facilitate positioning such waist strap ends during storage one or both edges of each of the sidearms may have a positioning niche formed thereon. This may be in the form of an inwardly descending edge that terminates in a buttress face that serves to limit the sliding of the waist strap on a sidearm.

In cases where the neck cords terminate and are anchored at anchor points on the backing plate or sidearms, their disengagement from the engagement points will permit the computer to be supported by the neck cords at points that are closer to the center of mass or balance point of the computer/support combination. In this configuration a waist strap, while still advantageous, is less needed to ensure balanced stability during deployment. Omitting the waist strap facilitates quick deployment followed by storage of the computer from and to a hanging position on the side of a user. However, as addressed further below, the waist strap can be employed when the side carrying mode for the computer is combined with a quick partial deployment against the hip of a user.

The neck cords may terminate directly or indirectly at anchor points on the two movable arms. A preferred arrangement is for these anchor points to be on stub extensions of the two arms providing for a convenient shifting of the anchor points between stored and deployed modes for the swingarm. Such stub extensions are located on portions of the arms that extend past the direct computer connection point for the arms, protruding away and being remote from the outer deployable arm ends that are joined by a bridge to form a U-shaped propping member. The direct computer connection points for the arms are the points where the arms may be pivotably connected to a computer or to a backing plate assembly carrying the computer.

### Neck Strain Relief Support

As a further feature of the invention, in order to reduce user fatigue caused by pressure applied by the neck straps or cords onto the back of the user, a tensioned neck relief-strap may extend from such cords down to the user's belt or other anchor point at the back of the user at waist level. With a neckstrap sleeve present this relief-strap may be connected, preferably disengageably, to the sleeve. Alternately, with a neckstrap sleeve present, the upper ends of the neck relief strap may disengageably connect with the neck strap itself adjacent to the outer ends of the sleeve. The sleeve serves to shift the load on the user further outwardly on the shoulders and away from the user's neck. Length adjustment of the relief-strap may also be provided.

For the relief-strap to connect at the respective outer ends of the sleeve it will have two portions: two uppers ends connected to the neck cords at spaced-apart points provided by the neckstrap sleeve and lower ends connected to form a “V”. Engagement with the user's belt in this variant occurs at the downwardly directed apex of the “V” where a middle strap hook disengageably and preferably slidingly engages the belt or waist level anchor point. The relief-strap is preferably a single piece with two portions that can slide at the “V” apex. The object in this variant is for the two upper ends of the relief-strap to pull down with similar force on the left and right sides of the neckstrap sleeve, and in all events at separated locations to give improved weight distribution onto the user's shoulders.

In another embodiment of the neck pressure relief feature, the body support member is affixed to the computer or computer support at its respective two forward ends with a middle strap hook affixed near the middle of the cord for engagement at the back onto the user's belt or similarly located anchor point. Left and right cord length adjusters can and preferably are incorporated into the body support member in this arrangement. The user drapes this large adjustable-length strap over their shoulders such that the middle hook hangs down to form a “V” down their back, the apex of which is engaged to their belt or to the elastic waist strap used to stabilize the computer support, thereby forming a computer support harness over the user's shoulders. Adjusting the strap to a medium length enables the user to sling the computer over one shoulder for transport. Adjusting the strap to a minimum length and disengaging the middle strap hook enables it to be used as a conventional neckstrap, in which case a removable sleeve may be engaged over the strap to act as a neck cushion.

In yet another embodiment of the neck pressure relief feature, the body support member includes a vest or similar garment worn by the user, the garment having anchor points for carrying the weight of cords extending down to the computer support and the computer. The garment may include an enclosing sleeve for an elastic waist strap included with the vest.

Receiving Case with Screen Cover

As referenced earlier the computer may be carried on a backplate that extends between the two sidearms of the computer support. As an alternative a receiving case, often referred to as a “folio case” when a cover is present, may be incorporated into the computer support to carry the computer. Such a receiving case may be mounted on a backing plate or may itself extend between the two sidearms to carry the computer. As is known such cases have side edges dimensioned to grip a computer and retain it in place. Openings in the sides of the case provide access to the computer ports. The case may include a camera-hole to accommodate a particular tablet's back-side mounted camera lens.

Such cases typically have a screen cover hingedly mounted along one edge of the case. As an alternative in association with the computer support of the present invention, a screen cover may be hingedly mounted along one edge the backplate of the computer support, positioned to either overlie the computer screen or to be rotated, eg through 270 degrees, to expose the screen. To effect the required hinge fixation while maintaining a clean appearance, a hinge flap portion of the screen-cover located on the other side of the hinge line from the screen cover may be pinched or sandwiched between the backplate and a computer mounted thereon. To accommodate the thickness of the hinge-flap portion a suitable recess may be provided in the backplate. Or the flap may be bonded to the receiving case.

The fairleads of the invention may be mounted on or carried by the receiving case when such is employed.

Typical screen covers of this type are segmented into portions, eg three panels, that enable the folded cover to act as a triangular tablet-stand when placed on a table. These screen covers often include magnets that operate switches within the tablet to automatically turn the computer on or off depending on whether the cover is in place or not. Such segmentations can co-operate with an accessories bag subsequently described herein.

### Computer and Computer Support Enclosing Bag

As another feature of the invention a bag preferably with a loop finish may be provided to cover or enclose the computer or the computer and its support. To configure the computer/support for carrying in the bag the neck cords may be first disengaged from their respective fairleads if present to remove stress from such fairleads and facilitate such cords to carry the weight of the computer with preferred balance. The bag's outer surface may have a plush “loop” outer finish that enables any Velcro™ hook surface to adhere to it. For example, second bag to having a Velcro™ hook surface may be adhered to the bag with the loop finish.

A user may wear apparel with Velcro™ hook surface portions as, for example, on their belt or at their waist, to which the bag may be attached for storage during computer use. These patches may also serve to park the ends of an elastic waist strap. Alternately or additionally the undersurface of the backing plate of the computer support may incorporate Velcro™ hook surface portion to which the bag may be also attached during computer use.

### External Accessories Storage Bag

An accessories storage bag or fabric cargo pouch may be dimensioned to be detachable fitted onto a hinged screen-cover. The cover in such case may be attached to a receiving case or mounted to a backing plate. Such bag includes a closable upper opening for retaining sundry items therein. The front, outer-facing fabric surface of the bag preferable has a printable surface for presenting decorative graphics.

The back surface of the bag includes at least patches of hook-and-loop fastener material positioned for engagement with corresponding material mounted on the outer surface of screen-cover. To facilitate actuation of the swingarm mechanism, the fabric used to form this bag is preferably soft and flexible, enabling it to deform easily and pass over the user's fingers as screen-cover is swung from open to closed positions. These characteristics also allow the bag to be as large as the outer perimeter of the computer support, screening it from view. Concealing the utilitarian mechanism of support provides the appearance of a shoulderbag which may have aesthetic appeal for consumers.

Providing the bag with an outer printable surface allows it to be decorated with images that will enhance consumer appeal. By providing consumers with bags with differing graphics options, portable computers carried in computer supports according to the invention can be decorated in accordance with social circumstances, according with the fashion preferences of consumers.

The printable bag can be enhanced by gluing a mosaic of ornamental fabric patches onto its printed surface, preferably using a heat-press to fuse their heat-sensitive backing onto the substrate. To enhance the bag's cargo carrying capacity and versatility, some of these glued-on fabric tiles may be Velcro loop patches for engagement onto corresponding hook patches that removably affix one or more outer pouch modules that can be used for externally carrying items such as sunglasses, keys or earphones for easy access.

### Folding Computer Cover

As an alternative to providing a protective bag or sleeve, a folded protective sleeve made of planar sheeting can be cut to provide top and bottom portions with a joining edge surface portion therebetween. These portions are connected together along plastic hinge lines formed by scoring the material. The bottom portion of the sheeting is dimensioned to fit against the backplate of the computer support, or computer, to which it is removably affixed. Plastic hinge lines on either side of the joining edge surface portion permit an upper sheet portion to be swung into a position over the computer screen where it can serve as a sunshade. Conveniently, side flaps extending laterally off the upper sheet can be folded about score lines to permit such side flaps to extend downwardly to the neck cords. Notches cut into the side flaps can be used to engage with such cords. The bottom portion and joining edge surface need not be present when the upper surface portion alone is used as a sunshade.

The bottom portion when present may be removably attached to the backing plate through Velcro™ fasteners. The top and side flap portions can similarly be provided with such fasteners allowing them to be folded into a storage position either covering the screen of the computer, or, rotated by 180°, fitted for storage during computer use against the bottom portion of the protective sleeve. Further Velcro™ fasteners present on these planar services can be used to attach additional storage bags.

As a further variant, the inner surface of the top portion of this protective sheeting can carry a low-profile mechanical keyboard. When the computer is positioned on a tabletop using the computer support to prop it up at a good presentation angle, the attachment of the lower sheet portion to the computer can be reversed so that the formerly upper protective panel lies flat on a table top, presenting the keyboard for use. Various known forms of electrical communication between the keyboard and the computer may be employed.

### Accommodation of Separate Keyboards

To accommodate computers with affixed or separable mechanical keyboards wherein the keyboard portion is or may be connected to the screen portion, e.g. the “MS Surface™” style of computer, the screen portion may be affixed to the backplate for normal deployment outwardly away from the user. Upon deployment of the screen, the keyboard is swung upwardly and towards the user, directed towards overlying the bridge.

The arrangement just described, in the case of a standard computer support as previously described may place the keyboard unduly close to the torso of a user. To position the keyboard more conveniently outwardly from the torso of the user the side arms can be structured to telescopically extend, with their user-side ends joined by a separate, second, bridge member, outwardly from the computer support towards the torso of a user. This telescopic extension feature will thereby increase the length of the two sidearms when deployed.

The extension arms can have indexed stop positions enabling the degree of extension to be selected by a user. Locking engagements within the arms can allow for varying degrees of extension. When collapsed for storage the extension portions of the sidearms can be parked closely adjacent to the regular sidearms, and the supplementary bridge can nest against the normal bridge.

### Adaptation for Tripod Fitting

As another variant of the invention one or more mounting holes may be formed in the swingarms dimensioned to receive and engage with a camera-fixation coupling such as a threaded shaft having, for example, a ¼ inch-no 20 thread on a camera tripod. With such threaded holes formed in the computer support the computer can be readily mounted on a standard camera tripod. Such holes may be positioned on the swingarm in close proximity to the point of direct computer connection to improve the stability of support for the computer. Or such holes may be positioned on the swingarm at a location which is in near alignment with the center of gravity of the computer support-computer combination for improved balance. Other forms of connection may be employed, but the use of a threaded hole is preferred due to its simplicity. If the computer support does not have sufficient material for form a thread that's sufficiently robust then an adaptor fixture may be provided that presents the requisite threaded hole for fixation to a standard camera mount.

### Mobile Point of Sale Application

The computer support of the invention can have many applications. One application in the retail industry is to allow for sales staff to carry tablet computers ready to use in the computer support. As an example of a customer processing arrangement, sales take place directly on the floor with the sales personnel recording customer data and product purchase directly onto the tablet computer for communication to a central data bank. Products so purchased are recorded in the data bank as having accurately pre-determined weights. As the customer leaves the store, they present a token received from the sales personnel, or otherwise associated with the goods that have been acquired and paid for on the store floor. This token is proof of payment which is presented to an individual or a machine on exiting the premises.

To minimize inappropriate removal of goods from the premises, the collection basket or cart of goods purchased in this manner can be weighed at this time of departure and the actual measured weight compared with the aggregate of pre-recorded weights for the paid-for products as stored in the institutions data bank minus the known weight of the collection basket or cart. Customers whose measured weights are within the tolerance may then be permitted to leave directly.

The computer support of the invention facilitates this process by allowing the sales personnel to use the imaging camera on tablet computers to scan product barcodes and client identifiers.

The foregoing summarizes the principal features of the invention and some of its optional aspects. The invention may be further understood by the description of the preferred embodiments, in conjunction with the drawings, which now follow.

Wherever ranges of values are referenced within this specification, sub-ranges therein are intended to be included within the scope of the invention unless otherwise indicated or are incompatible with such other variants. Where characteristics are attributed to one or another variant of the invention, unless otherwise indicated, such characteristics are intended to apply to all other variants of the invention where such characteristics are appropriate or compatible with such other variants.

### BRIEF DESCRIPTION OF THE FIGURES

FIG. 1 is a schematic depiction of a prior art application with an individual carrying a tablet computer mounted in a computer support incorporating a number of features of that are complementary to the present invention.

FIG. 2 illustrates the prior art computer support of FIG. 1 reconfigured for transport.

FIG. 3 illustrates the prior art computer support of FIG. 1 carrying computer with an attached keyboard wherein the keyboard is carried by the base plate of the computer support.

FIG. 4 illustrates an arrangement according to the invention that relies on the engagement of the neck cord with the outer peripheral corners of the tablet computer of FIG. 1.

FIG. 5 illustrates the arrangement of FIG. 4 that incorporates a pair of wire hook fairleads at the neck cord-computer engagement points to position and stabilize the support cords.

FIG. 6 is an exploded underside view of the computer of FIG. 5 showing the fairleads mounted on the underside of the computer

FIG. 7 illustrates another “clip” embodiment of the fairlead cord guides shown in FIG. 5 mounted on the underside of the computer.

FIG. 8 illustrates further embodiment of the fairlead cord guide means shown in FIG. 5 with such wire fairleads mounted on the base plate.

FIG. 9A illustrates yet another embodiment of the fairlead cord guide shown in FIG. 5 with such fairleads incorporated into an extended portions of the base plate.

FIG. 9B illustrates the embodiment of the fairlead cord guide shown in FIG. 9A with the mounted computer folded into a stored configuration and a second alternative computer symbolically position to replace the mounted computer.

FIG. 10 illustrates and Original Equipment Manufacturer's (OEM) embodiment of the fairlead guide shown in FIG. 5 incorporated into the peripheral a edge of a tablet computer and the sidearms of the computer support mounted directly to the computer without the presence of a back plate.

FIG. 11 is an exploded view of FIG. 10 showing details of the swingarm to a computer connection.

FIG. 12 illustrates a computer mounted in the swingarm and fairlead configuration of the invention in an intermediate position while being folded for storage against the torso of the user.

FIG. 13 illustrates the computer support of FIG. 12 in its stored for transport configuration.

FIG. 14A illustrates an embodiment of the invention that does not utilize fairleads at the cord-computer engagement points with the chords terminating and being anchored at such points.

FIG. 14B illustrates an underside view of the embodiment of the invention of FIG. 14A.

FIG. 14C illustrates a pictorial view of the embodiment of FIG. 14A swung to an over-the-arm, side-positioned carrying location.

FIG. 15 illustrates a single neck relief strap for reducing neckstrap pressure onto the user's neck.

FIG. 16 illustrates a “V”-shaped alternative to FIG. 15.

FIG. 17 illustrates a protective bag or sleeve for transporting the computer support.

FIG. 18 illustrates storage of the protective sleeve of FIG. 17 on the underside of the base plate while the computer is being used.

FIG. 19 illustrates another storage mode for the protective sleeve of FIG. 18 by attachment to the apparel of a user.

FIG. 20A illustrates a supplementary bag or cargo module affixed to the protective sleeve of FIG. 17.

FIG. 20B is an underside view showing at the attachment of the base panel portion of a folding protective case to the underside of the base of a computer support as in FIG. 9A.

FIG. 20C is a topside perspective view showing the deployment of the upper panel portion of the folding protective case of FIG. 20A to serve as a sunshade over the computer screen.

FIG. 20D shows the computer support of FIG. 20C with the sunshade portion lowered down to cover the computer screen.

FIG. 20E reproduces FIG. 20D with the sunshade repositioned for storage beneath the computer against the base plate of the computer support.

FIG. 20F shows the configuration of FIG. 20D with the computer and computer support in a hanging orientation and a storage bag being attached to the lower base portion of the folding protective case which is fitted to the underside of the base of a computer support.

FIG. 20G is a rotated perspective view of the computer support with computer and protective case of FIG. 20F showing the upper portion of the protective case overlying the screen of the computer.

FIG. 21 illustrates means for affixing the computer support to a camera tripod.

FIG. 22A illustrates the deployed mode of a telescopic computer support of the invention for supporting a style of computer similar to that shown in FIG. 3 having a hinged keyboard but with the computer screen mounted on the faceplate.

FIG. 22B is an underside view of the computer and computer support of FIG. 22A.

FIG. 22C is a depiction of the computer and computer support of FIG. 22A in a hanging orientation similar to FIG. 20F.

FIG. 22D depicts a table-top positioning of the computer with protective case of FIG. 20C positioned with the upper panel portions positioned on the tabletop surface and presenting a touch sensitive keyboard for controlling the computer.

FIG. 22E depicts the computer support and computer of FIG. 22D deployed on a computer support as shown in FIG. 22A.

FIG. 23A depicts a transaction between a salesperson and a customer on the floor of a store wherein the salesperson utilizes a computer support according to the invention.

FIG. 23B is a schematic plan of the layout of the store of FIG. 23A showing provisions for managing the departure of the customer from the store.

FIG. 24A illustrates a vest that includes means for relieving neck pressure.

FIG. 24B illustrates the garment and apparatus of FIG. 24A when reconfigured for mobile storage.

FIG. 25A illustrates a multi-mode carrying strap when configured as a shoulder harness engaged onto the user's belt.

FIG. 25B illustrates the strap of FIG. 25A when reconfigured for transporting the computer by slinging it over one shoulder.

FIG. 25C illustrates the strap of FIG. 25A when reconfigured to serve as a neckstrap.

FIG. 26 illustrates an embodiment of the invention that uses a full-coverage receiving case to affix the tablet computer to the swingarm mechanism

FIG. 27 illustrates the embodiment of FIG. 26 from the opposite side showing the receiving case's hinged protective screen cover closed over the tablet.

FIG. 28 illustrates an alternate configuration of the receiving case shown in FIG. 26 which integrates the backplate's discrete swingarm and fairlead elements into a single moulded part.

FIG. 29 illustrates the embodiment of FIG. 26 and FIG. 27 when its swingarm is in its opened configuration for hands-free mobile use of the tablet computer.

FIG. 30 illustrates a detachable cargo pouch that can be affixed to the hinged screen cover.

FIG. 31 illustrates the embodiment of FIG. 27 when equipped with a cargo pouch such that it can be carried and used as a shoulderbag.

FIG. 32 illustrates the hands-free configuration of FIG. 29 when a cargo pouch is attached.

FIG. 33 illustrates an alternate usage configuration for rapid, hand-held deployment from the asymmetric shoulderbag configuration of FIG. 31.

### DETAILED DESCRIPTION OF THE DRAWINGS OF PREFERRED EMBODIMENTS

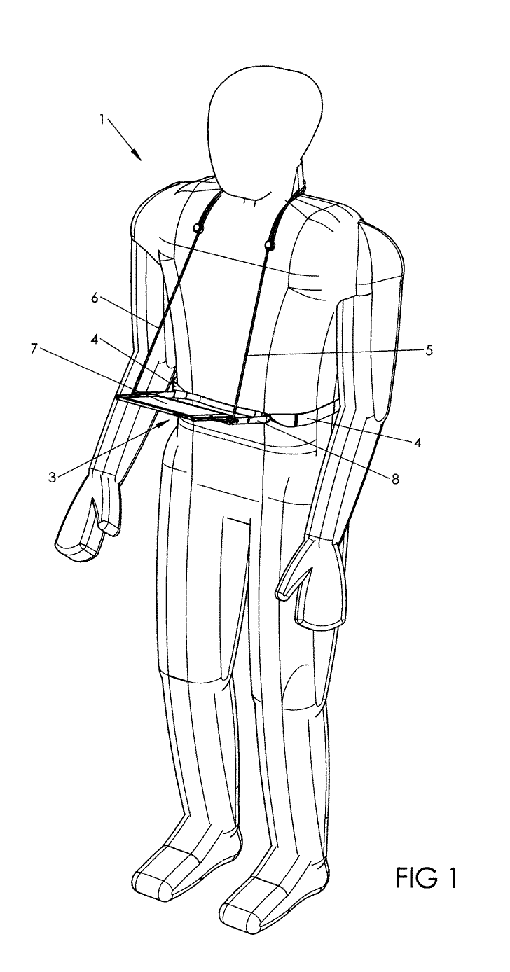

FIG. 1 shows the prior art computer support 3 of the “342” PCT application. An optional waist strap 4 has been deployed around the user's 1 waist to secure the deployed swingarm 8 to the user's torso, thereby enabling computer 7 to be more easily operated while the user is moving about vigorously. Note that to operate computer 7 the user must manoeuvre their hands inside of the two neckstrap cords 5 and 6. This ergonomic inconvenience is exacerbated when smaller portable computers are being carried because the stand-off distance afforded by a smaller swingarm contributes to restricting the user's freedom of movement.

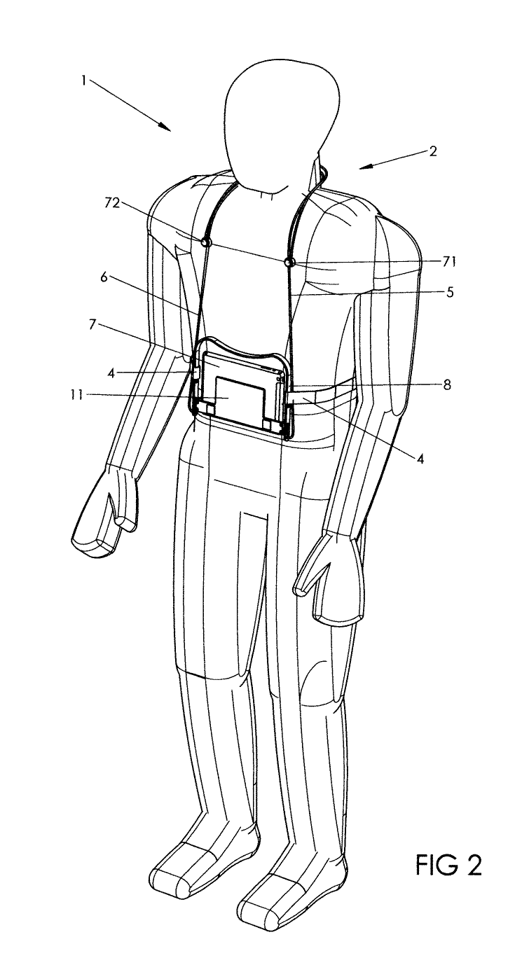

FIG. 2 shows the same prior art computer support of FIG. 1 when repositioned for stored transport by an active user. The tablet 7 has been folded into its parked position between swingarms 8 and then the assembly has been rotated 90 degrees for storage with the screen of the computer pressed against the user's torso. In this configuration the lower ends of neckstrap cords 5 and 6 hold the computer at a comfortable height against the user's stomach. Neckstrap assembly 2 includes left and right cord-length adjusters 71 and 72 for rapid height adjustment as needed. Waist strap 4 has been repositioned along the sides of swingarm 8 to a more central position that will tension computer 7 with more balanced force against user 1 for secure transport while the user moves about vigorously.

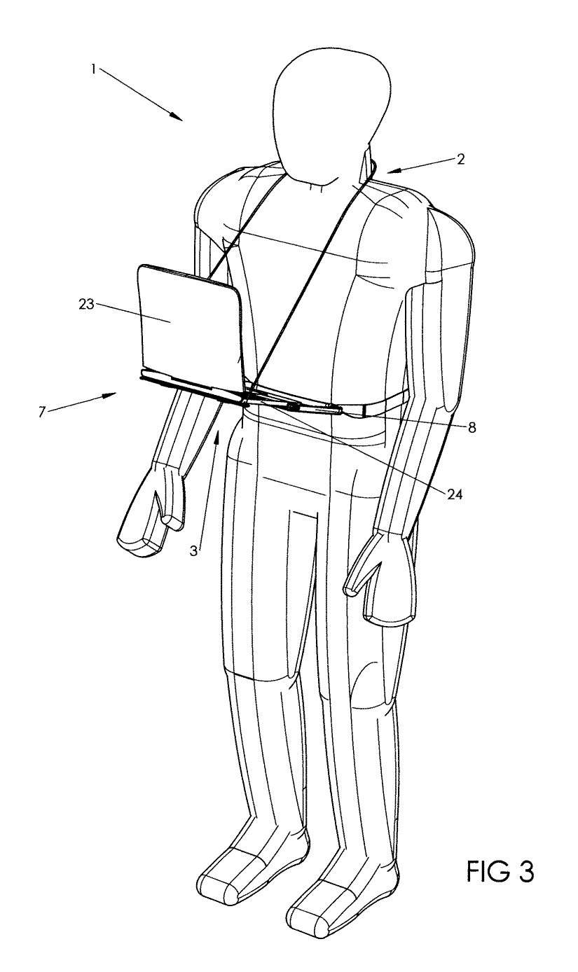

FIG. 3 shows another configuration wherein computer 7 is a laptop computer instead of a touchscreen tablet. In this case the clamshell style of computer's keyboard portion 24 is affixed to computer support 3 instead of the screen portion 23 of the tablet-style computer of FIG. 1. For storage or shoulder-carrying the computer by neckstrap 2, the screen portion 23 as folded over the keyboard portion 24 and then the combination is rotated together into a parked position between the swingarms 8.

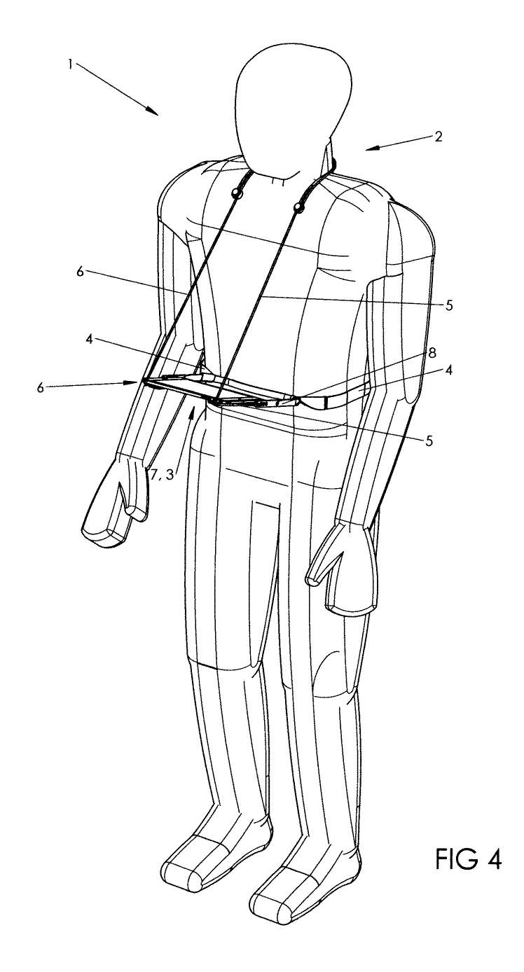

FIG. 4 shows an improvement according to the invention of the prior art configuration of FIG. 1 after the user has first lengthened neckstrap cords (5, 6) and then used the extra cord length to re-route such cords to bend around engagement points on computer 7 near its left and right outer corners and on to their anchor points on the two ends of U-shaped swingarm 8. Re-routing moves the vertical portion of cord 5, 6 out of the user's way for easier side access to the computer. Waist strap 4 secures the deployed swingarm 8 to the torso of user 1, thereby securing a large triangular side access zone that enables hands-free usage of computer 7 while the user moves about vigorously. Note that this ergonomically optimal positioning of computer 7 with respect to the user's hands is maintained regardless of their posture. Standing, sitting or lying down does not alter the computer's ideal, hands-free wearing geometry.

Unfortunately, with cords 5, 6 simply slid over the outer edge of the computer at its corners, the improved side-access configuration depicted in FIG. 4 is inherently unstable. This is because, if the user moves about vigorously, one or both of the cords is likely to slip off the corners of computer 7, thereby causing the computer 7 to topple forward until arrested by lengthened cords 5, 6. Some portable computers have a high-friction surface on their housing which might tend to retain the cords routed over their forward corners for periods of time, but this is not reliable. Furthermore, it still takes time and effort to properly re-position the cords as shown every time the computer and support are reconfigured between the storage and operative modes.

Regardless of the computer housing's friction characteristics, without the inclusion of further features, actuating the swingarm mechanism will almost certainly cause the looped cords 5 and 6 of FIG. 4 to disengage from their optimal computer engagement positions and foul into the swingarm mechanism. The present invention provides means for reliably and automatically maintaining the stability of this freer wearing mode as the device is re-configured between its storage and operative modes.

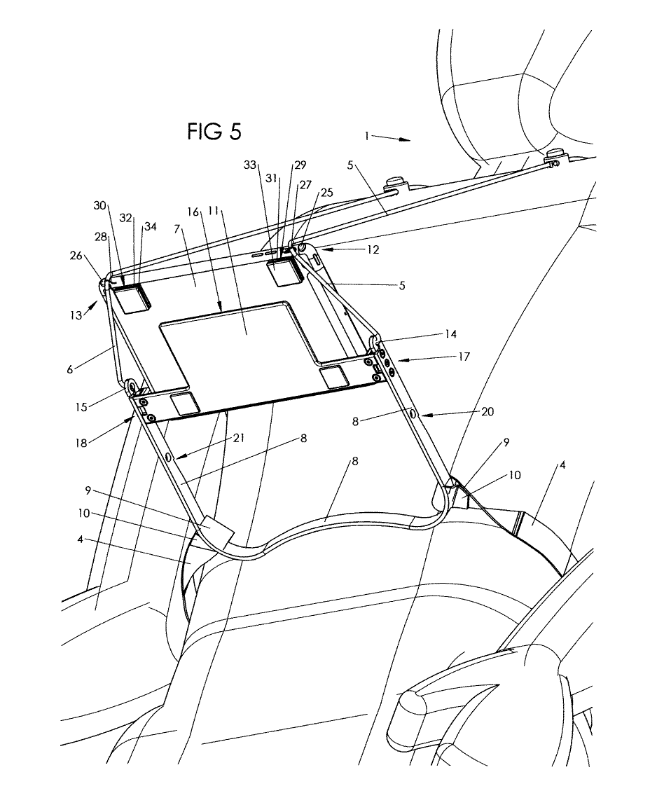

FIG. 5 is a lower oblique view of an embodiment of the present invention that stabilises the desirable cord geometry of FIG. 4. Left fairlead 12 and right fairlead 13, both in the form of looped wire that has a spring resilience are affixed to computer 7 near its outer corners. This advantageously constrains cords 5 and 6 to reliably continue to follow along the desired, triangular paths to their respective anchor points 14 and 15 on U-shaped swingarm 8.

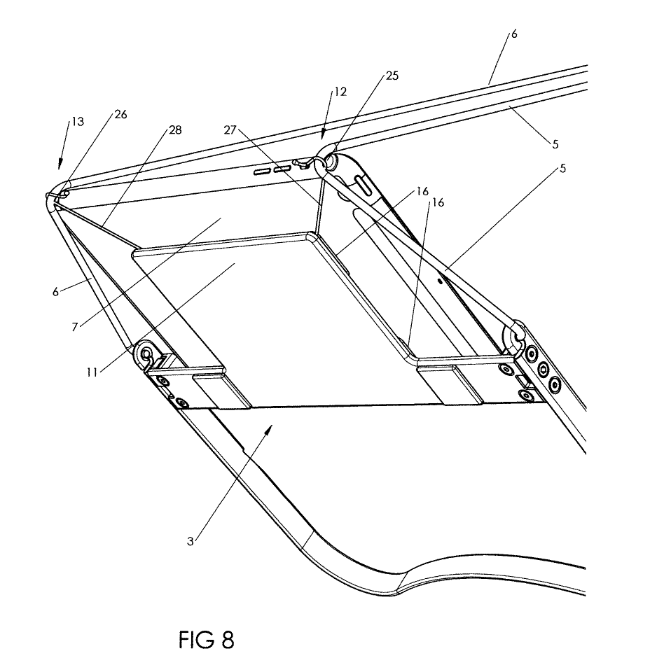

Note that the bottom surface of computer 7 in this variant is affixed to backplate 11 using fixation means 16, which are further described below. At the outer edges of the backplate 11 are left and right disengagable, rotatable locks 17, 18 which serve as direct connections between the swingarm and the other portion of the computer support provided ie, the backplate 11. These locks 17, 18 enable the computer 7 to selectably swing and lock into its storage position within the frame formed by U-shaped swingarm 8 with its bridge portion 8. The “342” application describes various fixation means 16. In a preferred embodiment, computer 7 and backplate 11 are joined using one or more 3M Dual-Lock™ adhesive strips; which securely and repositionably lock the two parts together. Use of this fixation means (visible in FIG. 8) facilitates carrying various computers of differing sizes on the same backplate.

Cord fairleads 12 and 13 may be multi-part assemblies that enable cords 5 and 6 to be securely prevented from slipping off the outer corners of computer 7. Fairleads 5, 6 are of a generally split-ring wire shape that allows the cords to be selectably engaged into or out of their retained paths as needed. This enables user 1 to easily reconfigure the cords to route directly to their attachment/anchor points 14 and 15 for use in the various operative modes described in the “342” application.

Since the forces applied onto the cords' contact points with computer 7 can be considerable, robust fairleads are required in order to prevent the oblique force vector towards attachment points 14, 15 from causing cord slippage that leads to failure of the support. To accomplish this function, fairlead posts 25 and 26 can be affixed directly onto the left and right outer corners of computer 7, thereby forming low notches into which cords 5 and 6 will tighten as tension is applied. Fairlead posts 25 and 26 may be typically adhesive disks approximately ¼″ in diameter that the user applies to their computer during the installation of support 3. Fairlead posts 25 and 26 are typically of flexible material such as adhesive-backed rubber or felt so that they conform to the shape of the computer while providing adequate blockage of lateral cord movement towards its corners.

When computer support assembly 3 is folded as described below, cords 5 and 6 will be forced to run through fairleads 12 and 13 when the cords are anchored to stub extensions on the swingarms 8. As swingarm 8 rotates, each cord runs through its respective fairlead a distance equal to twice the distance between its cord anchor point (14, 15) and its respective offset from the swingarm's axis of rotation (defined through the center of left and right locking means 17 and 18). The “342” disclosure allows for collocation of cord-ends (17, 18) along said axis and in such cases, the cord offset is zero and fairlead travel will be zero as well. But regardless of any swingarm-induced cord travel through fairleads 12, 13, cords 5 and 6 will often become slack as user 1 lifts the entire computer support 3 during performance of the manoeuvre needed to actuate and rotate its swingarm mechanism into either its deployed or stored mode. Thus; in order to prevent inadvertent cord disengagement from the computer's corners, a more restrictive fairlead structure that provides a detachable confinement, optionally slidable, may be provided to augment the reliability of the small cord notches formed at posts 25 and 26.

To retain slackened cords (5, 6) within the spatial zones needed for proper cord re-engagement onto said fairlead posts as cord tension is re-applied, left and right cord-guides 27 and 28 are provided and affixed to computer 7 using left and right attachment means 29 and 30. Since only light pressure is exerted by the slackened cords, thin wire cord guides will suffice and adhesive patches are sufficient as attachment means to hold them in place as one optional variant of this fairlead feature.

FIG. 5 also illustrates details of how waist strap 4 is configured. The waist strap 4 is preferably a length of soft elastic/cloth waistband material with adequate stretch to accommodate a wide variety of users and may include a buckle near its midpoint for further length adjustment. Each waist strap end includes a Velcro™ loop patch 9 and a Velcro™ hook patch 10, spaced apart such that the user can rapidly and easily secure each end around U-shaped swingarm 8 as shown in FIG. 1. Left and right patches of Velcro™ loop material may also be affixed to the inner surface of swingarm 8 (not illustrated), thereby enabling the Velcro™ hook on each end of the waist strap to mate onto rather than around the swingarm to secure it against the user's torso.

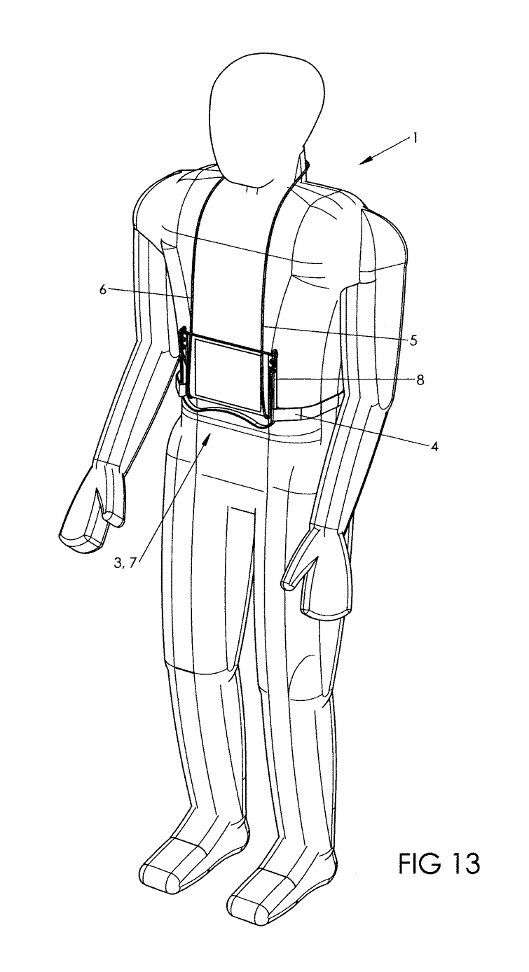

Each waist strap end should slide easily along the swingarm to enable the strap 4 to be repositioned more centrally along the arm 8 during storage. To facilitate positioning of the strap 4, left and right positioning notches 20, 21 may be provided. This strap 4 positioning feature enables the user to more easily reposition the strap 4 into the secure and balanced transport mode shown in FIG. 2. While strap positioning notches 20, 21 are shown on the top edge of each swingarm 8, similar notches may also be provided on the lower edges for use when storing computer 7 as shown in FIG. 13. When the computer is deployed and being used in landscape orientation as shown in FIG. 1, sliding the ends of strap 4 along swingarm 8 also enables the user to secure computer 7 to their body in portrait orientation (not illustrated). They do so by turning the computer 90 degrees to left or right while sliding both strap ends along the swingarm such that they secure either of its straight side portions to their torso instead of its curved end portion.

When not being used as shown in FIG. 1 and FIG. 2, waist strap 4 may be stored for transport by first spooling and securing it transversally around the opened swingarm 8 and then closing it to capture the strap against the back of computer 7.

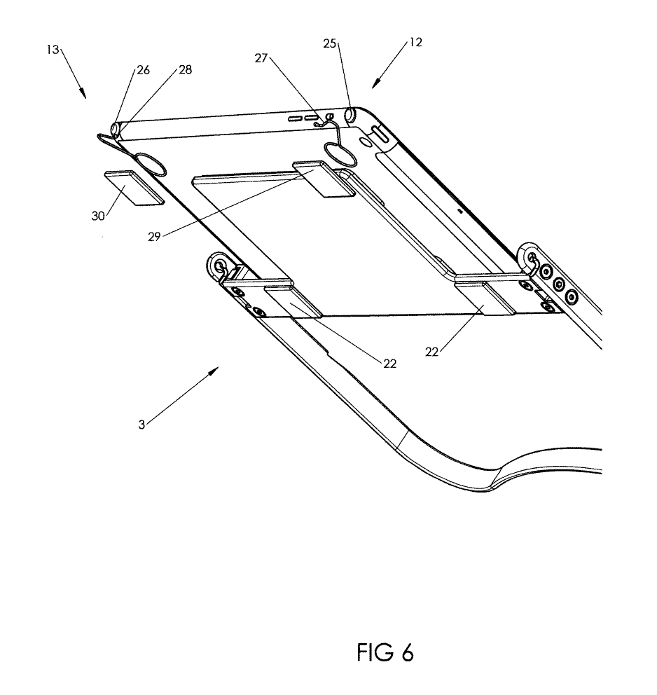

FIG. 6 is an exploded view of the 3-part fairleads 12 and 13 shown in FIG. 5. Wire fairlead guides 27, 28 are shaped and positioned to enable the user to insert or remove cords under its hooked shape, such that each cord is lightly held in place as shown in FIG. 5. Each cord is constrained by the hooked shape of its fairlead guide to run either on or slightly inboard of its respective fairlead post 25, 26. Each wire fairlead guide may be resiliently positioned with respect to its fairlead post to enable the cord to slide slightly along the front of computer 7 before arresting against its respective post (25 or 26). Attachment means 29 and 30 may be adhesive patches which cover a suitably shaped guide portion that provides adequate purchase (a ring shape in this illustrated example). A convenient embodiment of this adhesive attachment means is to use Velcro™ adhesive patches which thereby serve dual-purposes: they affix the cord guides in place and they also provide a Velcro™ “hook” surface for use in the bag-storage method described further below. Two extra Velcro™ “hook” patches 22 are illustrated for that bag storage purpose and will be referenced further below.

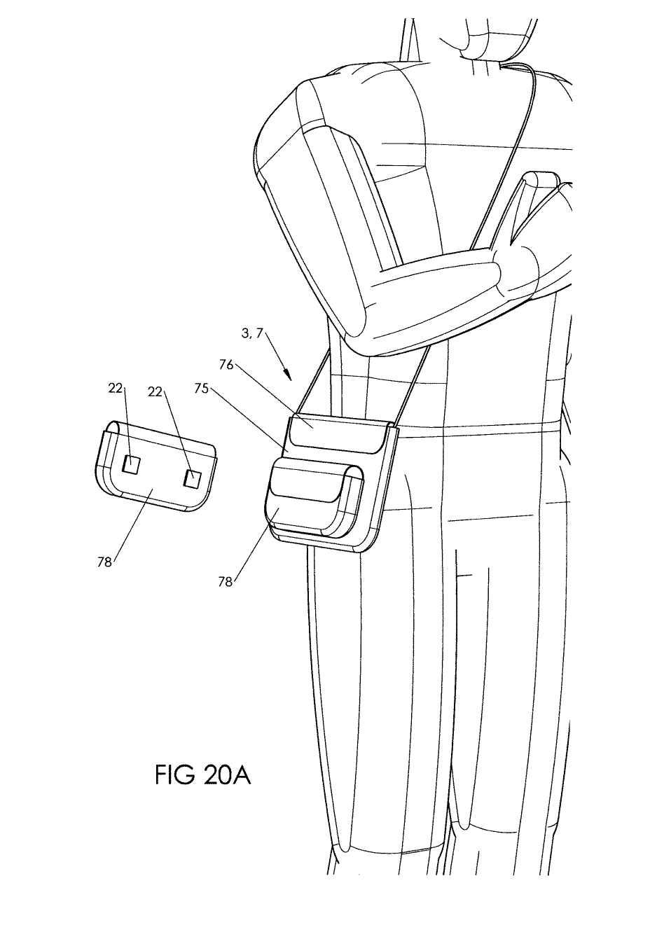

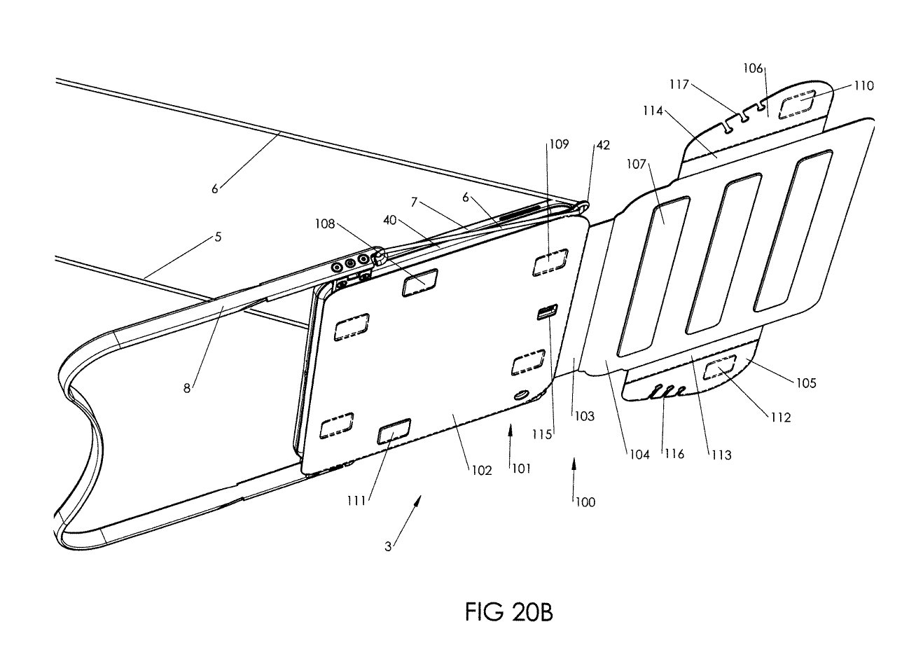

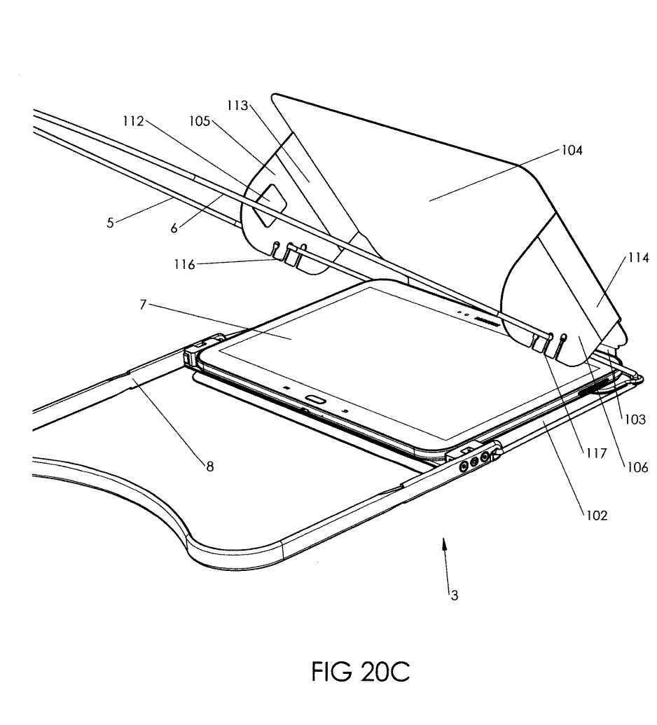

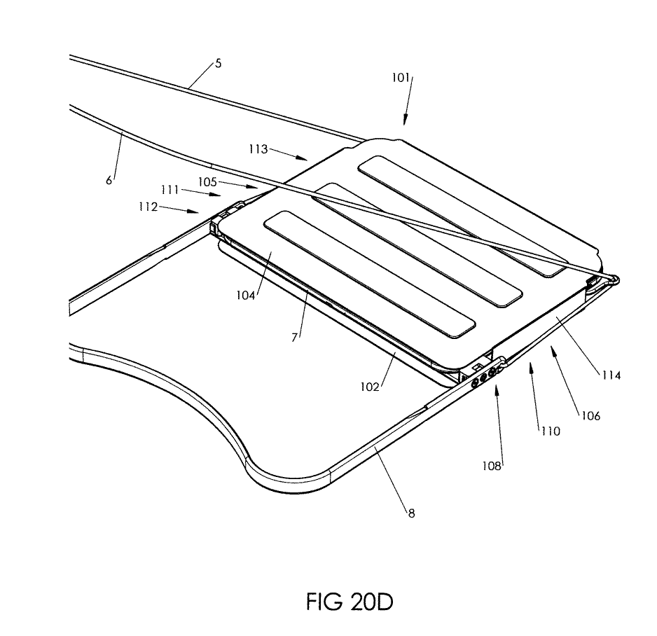

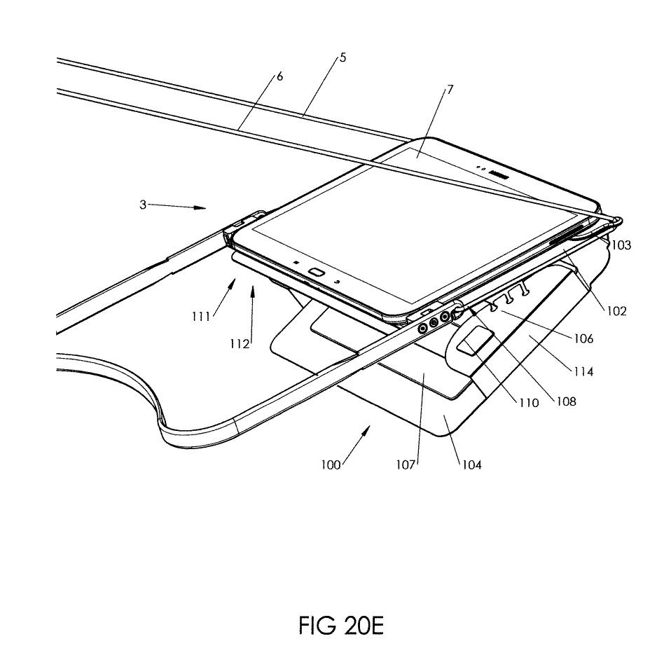

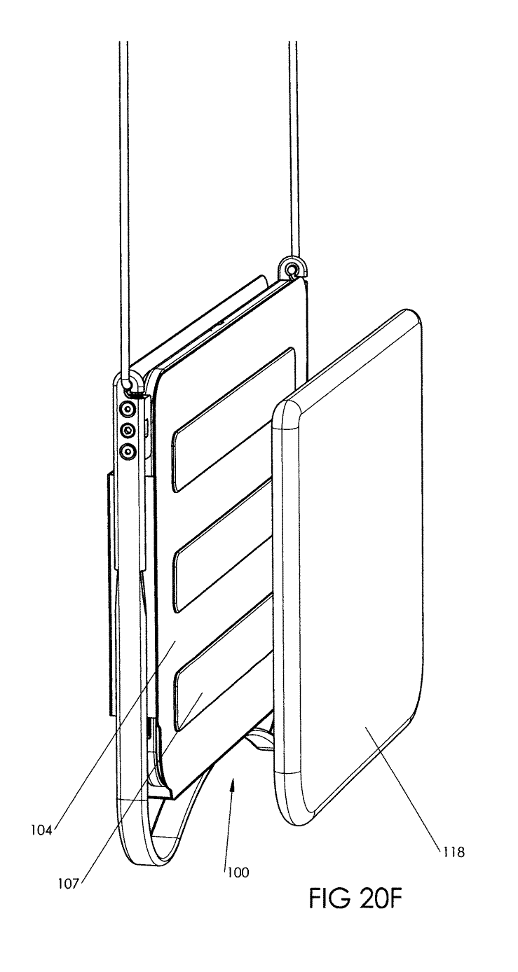

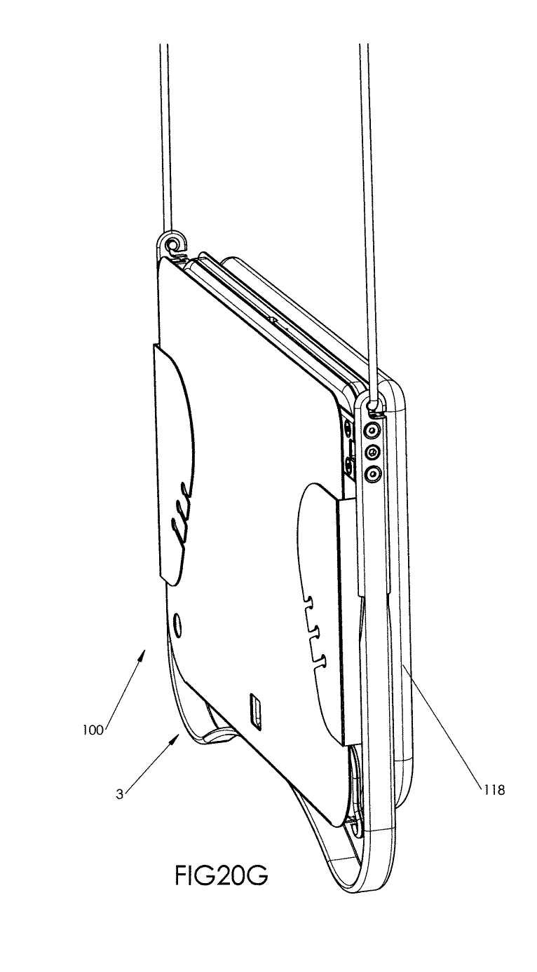

Referring back to FIG. 5, an alternate embodiment of the fairlead guide attachment means 29, 30 is shown. In FIG. 6, a single Velcro™ “hook” patch is used to semi-permanently affix each guide in place onto the back of computer 7. To provide an easily removable left and right fixation means, left cord guide 27 is sandwiched in between a Velcro™ “loop” patch 31 and a Velcro™ hook patch 33, thereby forming an easily detachable cord-guide module which can be affixed to the Velcro™ hook patch that is affixed directly to computer 7. Similarly; Velcro™ patches 30, 32 and 34 are assembled into a detachable right cord-guide module. Users will sometimes prefer to use their portable computer support in the basic configuration of FIG. 1, in which case these detachable fairleads modules can be removed and stored in the carrying bag described further below (see FIG. 20A). Other more rigid fixation means may be used and they may include snap-on-snap-off mating to computer 7 or baseplate 11.

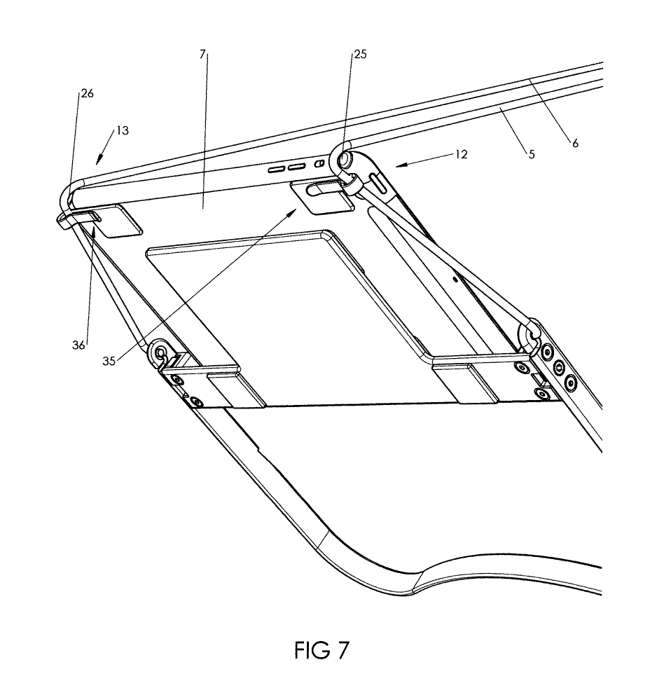

FIG. 7 shows an alternate embodiment of suitable fairleads 12, 13 that can be attached to computer 7. Left and right fairlead guides 35, 36 are moulded to integrate the functions of the cord-guides and fixation means shown in FIG. 6 into a single monolithic part. Guides 35, 36 are adhered to computer 7 to enable the required cord constraint function with respect to left and right fairlead posts 25, 26.

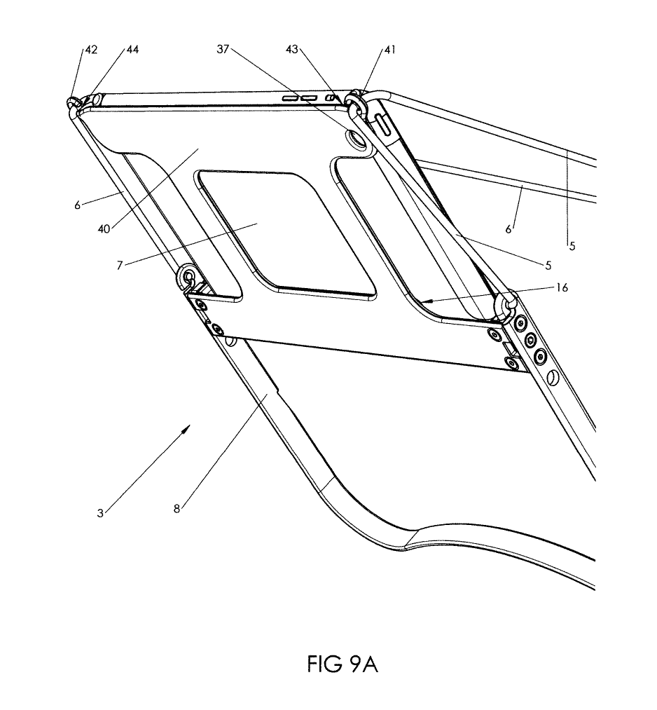

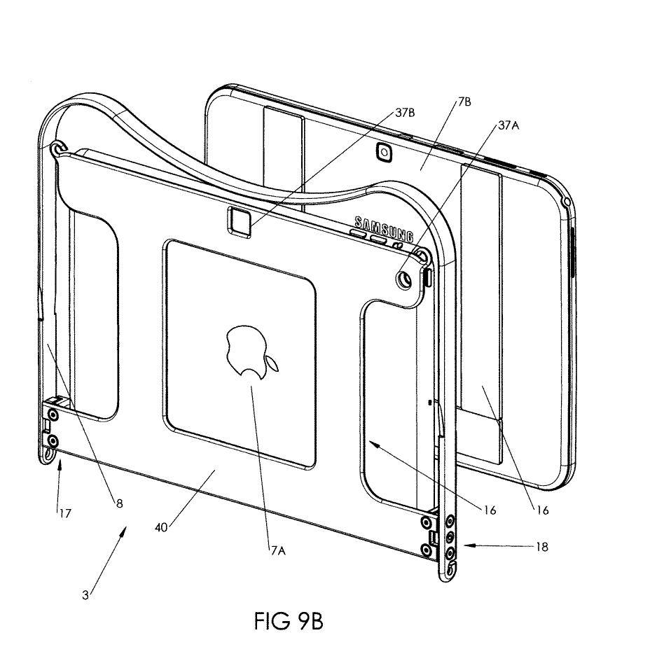

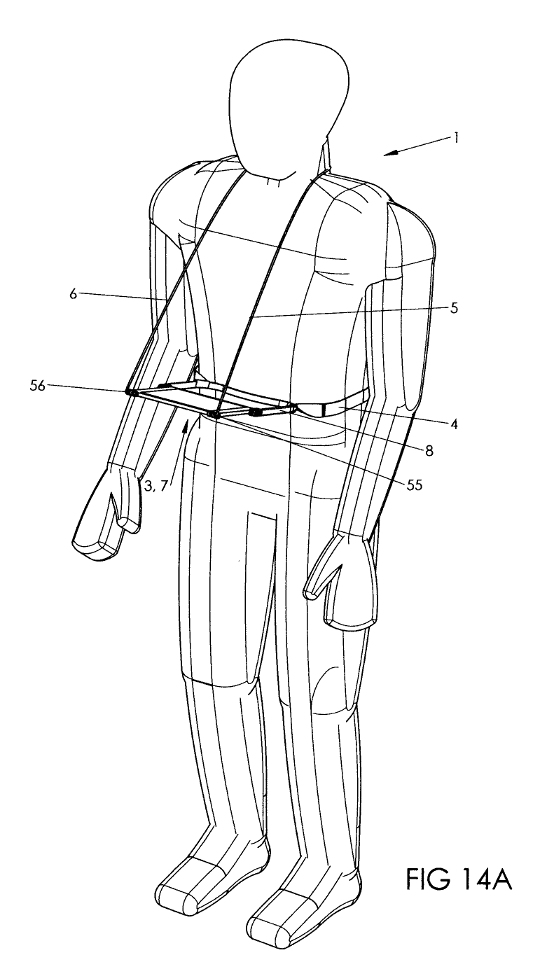

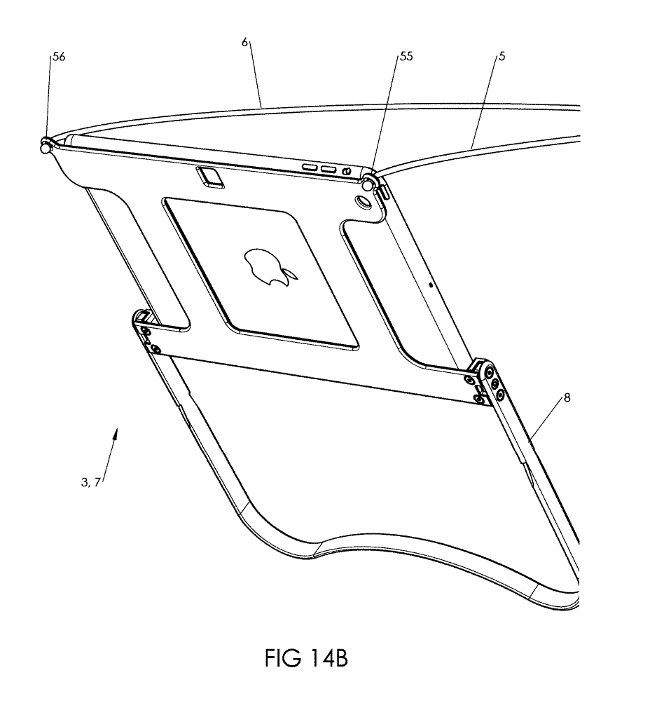

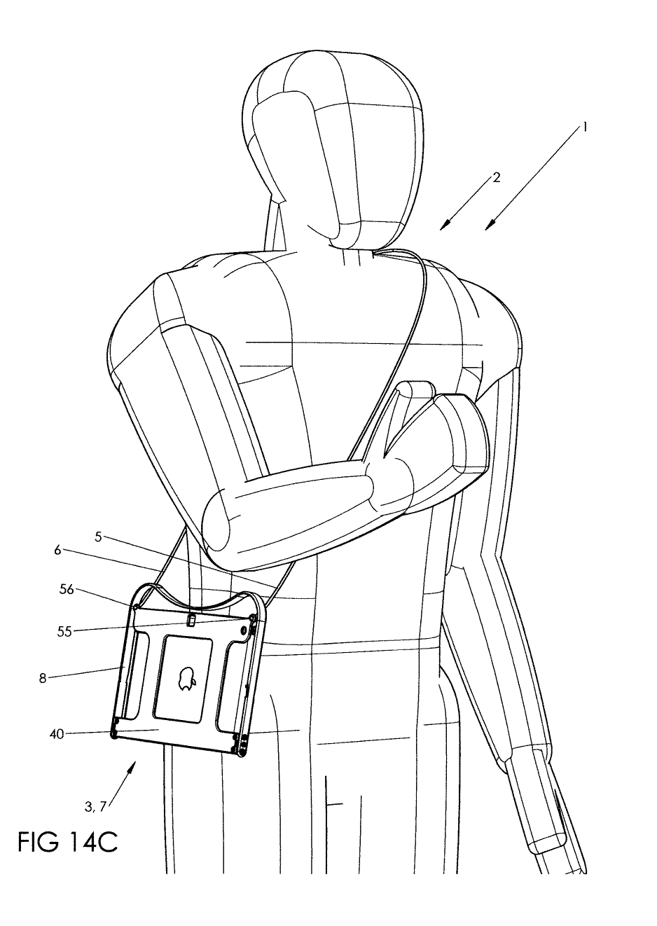

FIG. 8 shows yet another embodiment of fairleads 12 and 13 suitable for retrofitting to existing computers. Instead of affixing wire fairlead cord guides 27, 28 onto the back of computer 7, they are affixed onto backplate 11 of computer support 3. In this illustrated example, each wire fairlead guide 27, 28 is elongated and formed such that it provides adequate cord control while being mounted further away (on backplate 11). The wire guide may be affixed to the backplate by exploiting the 3M dual-Lock™ fastening strips 16 to sandwich the formed wire in place. More robust fairlead structures than the thin wire ones shown may be used, such as adjustable, rigid arms made of plastic that are suitably formed and affixed to backplate 11. These adjustable, rigid arms (not shown) extend outwards from backplate 11 to the left and right outer corners of computer 7. Such adjustable backplate extension arms can provide both the fairlead function of FIG. 9 and the cord-anchoring function of FIG. 14 in a structure that can be dimensioned to be retro-fitted onto a variety of existing computers of various sizes.

FIG. 9A illustrates use of an extended backplate 40 which includes left and right cord fairleads 41 and 42 formed integral to the plate's overall structure during its fabrication. This monolithic backplate and fairlead construction is simpler than the multi-part detachable fairleads described above. Being monolithic with backplate 40 also enables the fairleads 41, 42 to be positioned outboard of the left and right edges of computer 7, thereby routing cords 5, 6 where they cannot obscure the touchscreen of computer 7. Since maximum side-clearance for the user's hands is achieved by positioning fairleads 41, 42 forward of the computer's forward edge, optimal fairlead performance occurs when they are positioned at approximately 45 degrees (i.e.: both forward and outboard of the two front computer corners). The fairleads are typically hook-shaped to permit the cords to be easily removed when not in use; cord-gaps 43 and 44 are sized for slight interference with cords 5 and 6 so the user can easily engage or disengage the cords through each gap as needed.

Backplate 40 extends to the outer front corners of computer 7 and is typically designed to fit the exact shape and dimensions of a particular make and model of computer. For example, FIG. 9 shows a backplate that affixes to an Apple iPad Mini™. When custom-fitting a particular computer, special accommodation can be made for specialty sensors, which is why camera-hole 37 has been formed into backplate 40 as shown. The relatively complex-shape of backplate 40 lends itself to plastic injection moulding. Machined metal is also a suitable medium for fabricating plate 40.

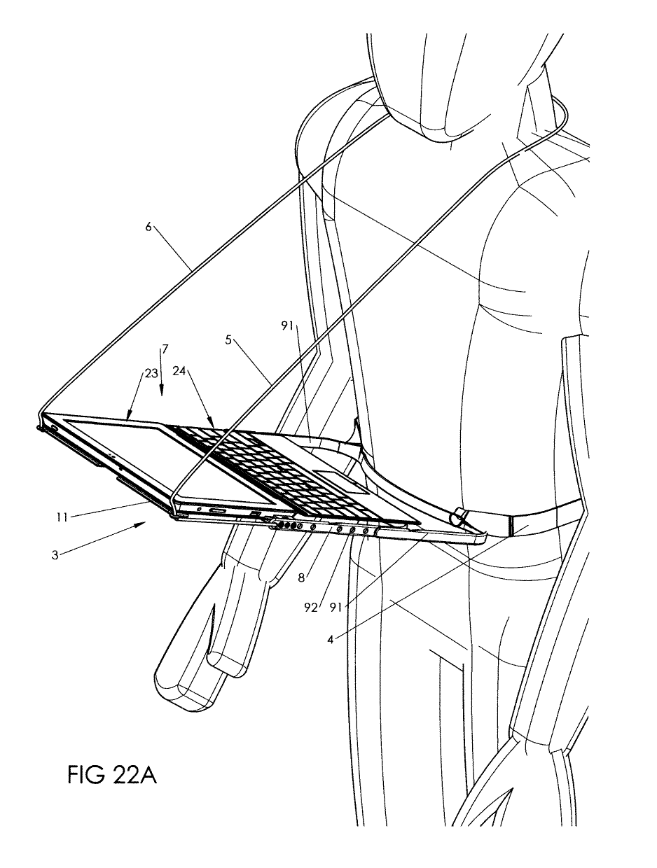

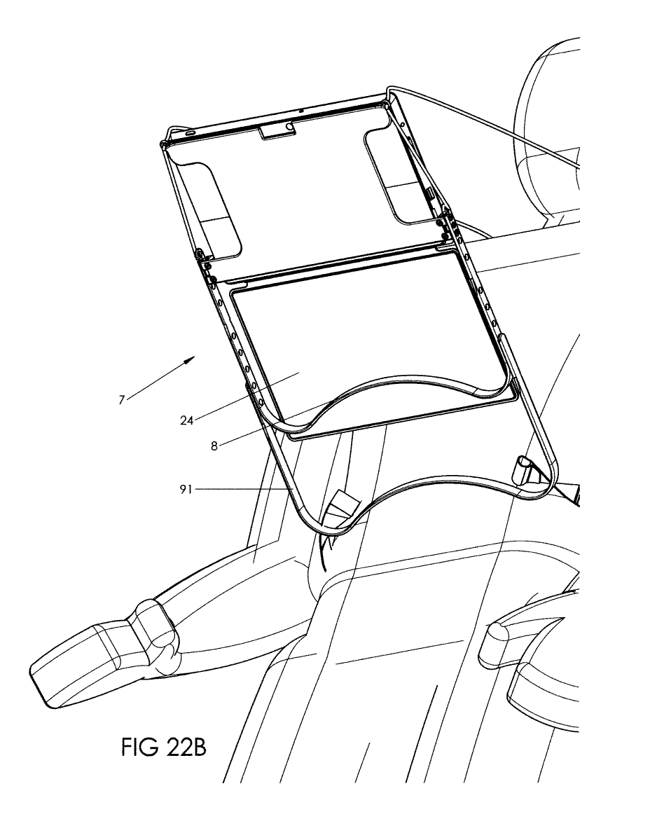

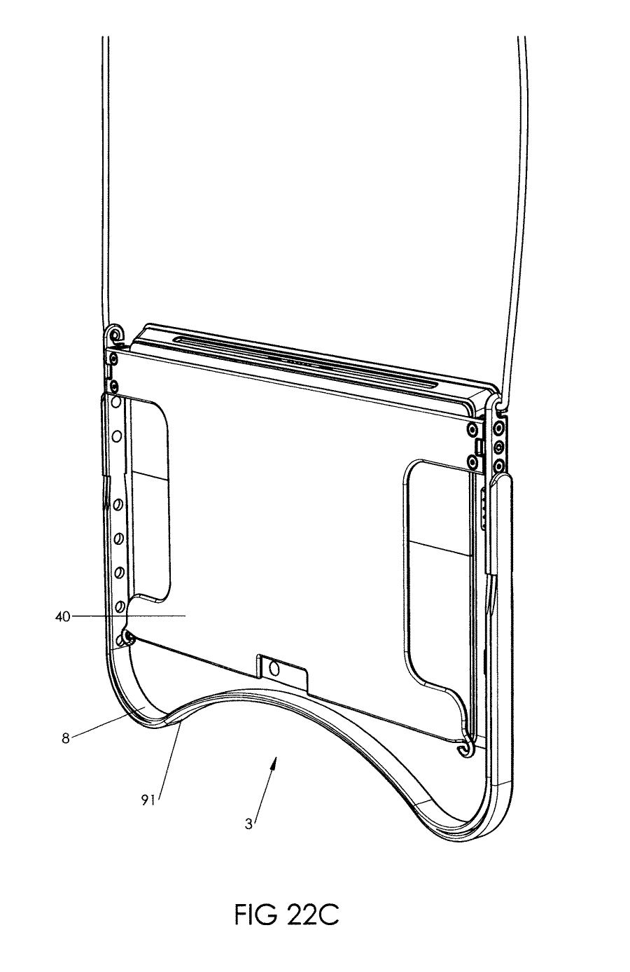

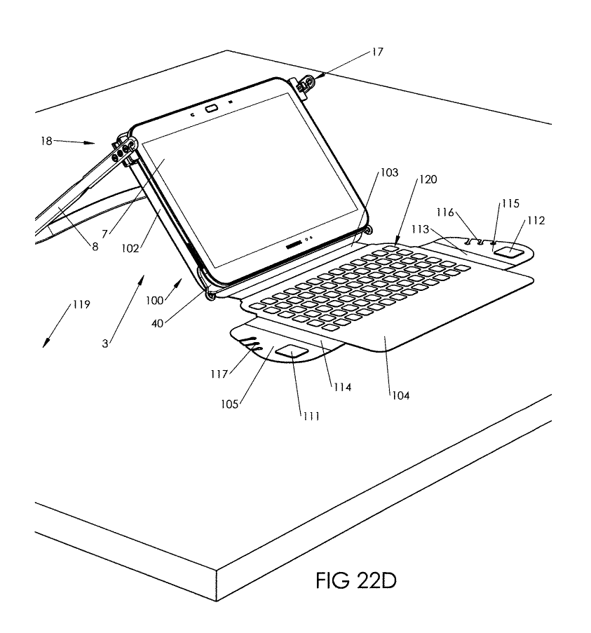

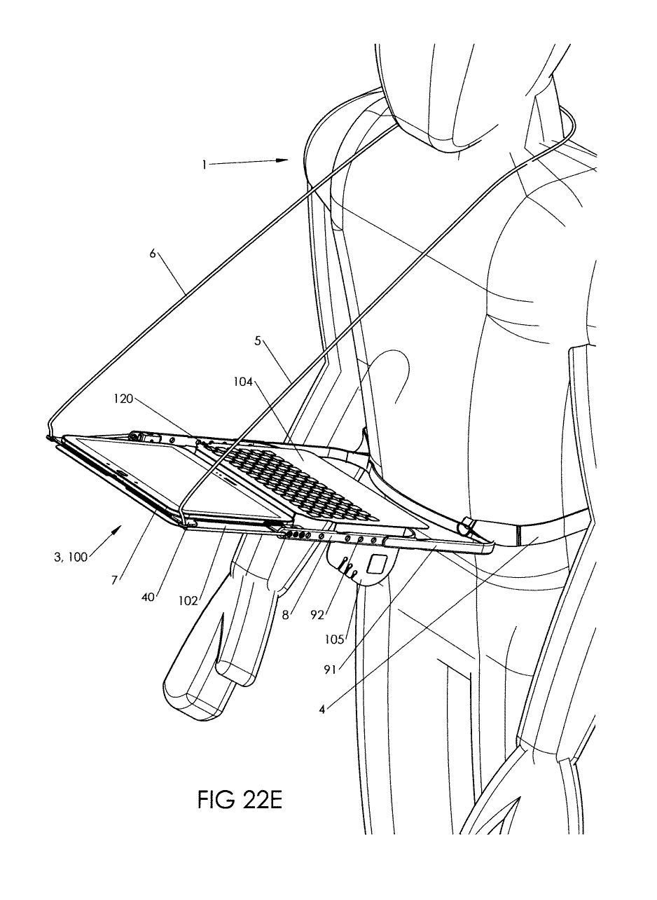

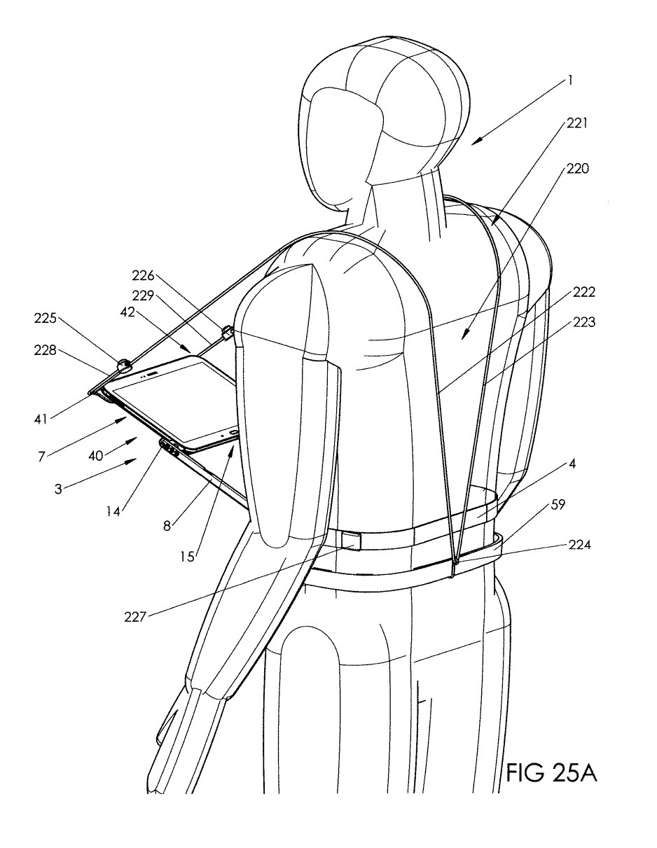

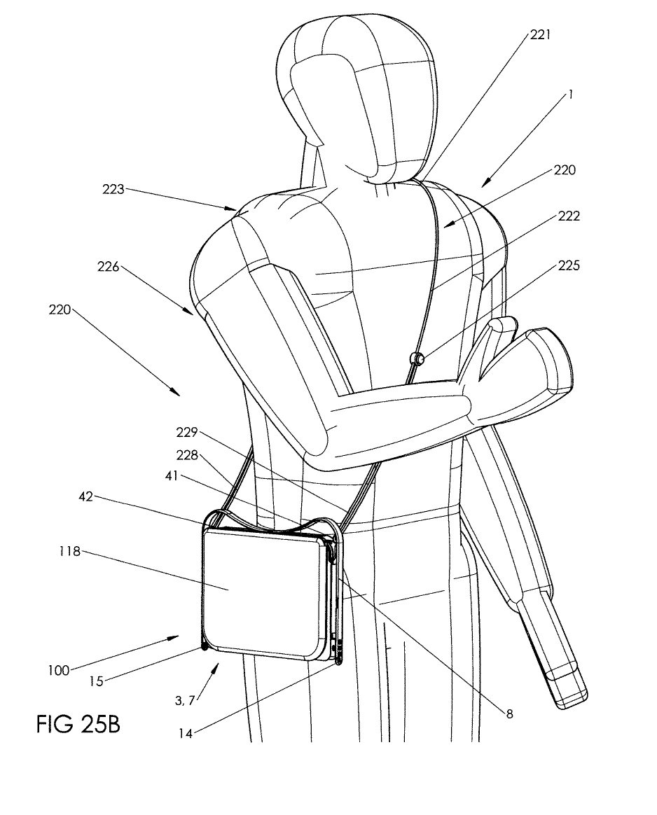

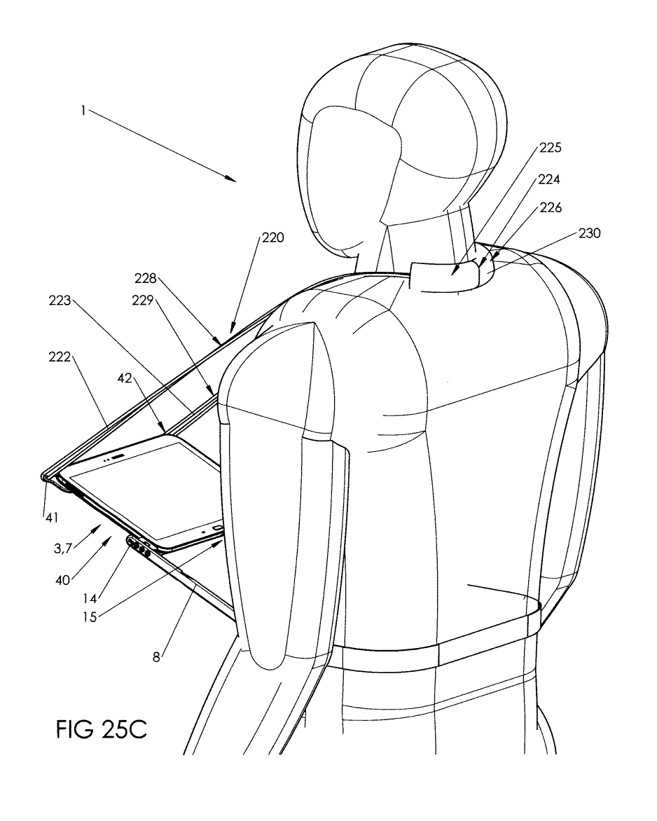

Monolithic fairleads 41, 42 form cord-hooks which may lie in the plane of backplate 40 as shown for ease of moulding during manufacture. Alternate fairlead configurations may be used to facilitate manufacture as well as to reduce cord friction (low friction being particularly beneficial for smooth operation of the multi-mode carrying strap shown in FIG. 25A). For example: stamped metal may be used to form the main portion backplate 40 and Delrin or similar low-friction plastic may be moulded to form small corner fixtures (not illustrated). Such moulded corner fixtures include optimally shaped (large diameter), low-friction fairlead hooks. The fairlead fixtures are subsequently fastened to plate 40 using screws or by over-moulding them onto the left and right forward corners of the metal plate. This more sophisticated manufacturing process facilitates forming a hooked fairlead shape that provides optimal cord routing geometry and cord friction characteristics. The more rigid backplate 40 enabled by using metal to fabricate its planar portion and plastic to form attached fairleads 41, 42 will also improve the performance of adhesive fixation means 16 used for joining backplate 40 to computer 7. For example: 3M Dual-Lock™ performs best when joining rigid flat surfaces). Alternatively; since the plate's shape is typically custom-fitted to each particular computer, mechanical edge-gripping finger means extending from the base plate 40 such as those shown in FIG. 22 of the “342” application may also be used. Note that for weight-reduction purposes, large cut-outs have been formed in backplate 40 however these may be omitted to improve appearance or to provide better protection for computer 7. Also note that the use of a metal backplate 40 augmented by separate plastic corner fairleads 41, 42 (not illustrated) will reduce production costs because a single corner moulding can be reused with a variety of metal plates formed to fit particular computers.

FIG. 9B illustrates the monolithic fairlead/backplate 40 of FIG. 9A reconfigured such that it fits more that one computer 7. In this example, both 7A (an Apple iPad Air™) and 7B (a Samsung Galaxy Tab 3 10.1™) can be dismountably affixed to the same backplate 40 using strips of 3M Dual-Lock™ 16 or similar fixation means. Two camera-holes 37A and 37B are positioned to enable either computer 7A or 7B to be mounted. Note that since computer 7B is slightly wider than computer 7A, swingarm 8 and its associated locking mechanisms 17, 18 are sized to fit the widest computer in the range of target computers so that all smaller computers such as 7A will fit with room to spare on each side.

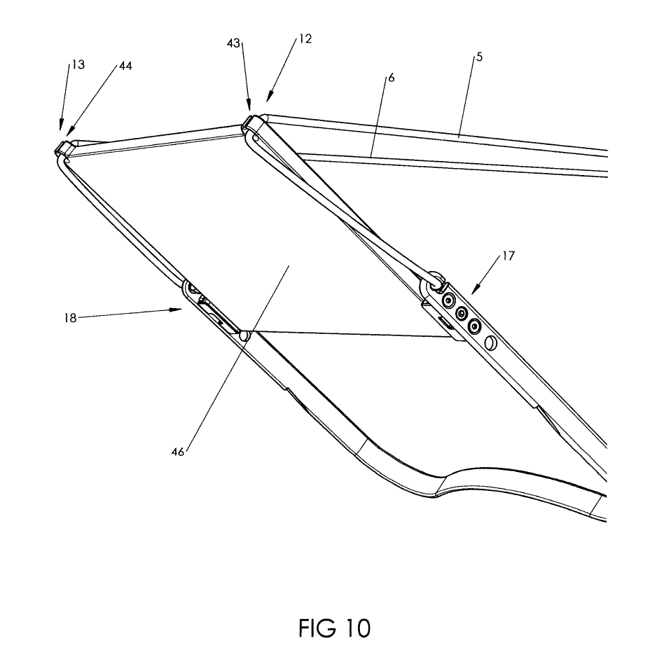

FIG. 10 illustrates an OEM implementation of the invention in which provision for mounting the computer support has been incorporated directly into a specially adapted computer frame or housing 46 during its manufacture. The swingarm's sidearm connections through rotatable lock mechanisms 17, 18 are made directly to the computer housing 46. Left and right fairleads 12 and 13 are formed into the computer housing's forward corners and include suitable fairlead gaps 43, 44 for selectably guiding cords 5, 6. Detachable fairleads that affix to mounting holes in housing 46 may also be used in place of the integrally moulded ones shown. Swingarm locking mechanisms 17 and 18 are affixed to holes near the rear corners of the computer 46 as described below.

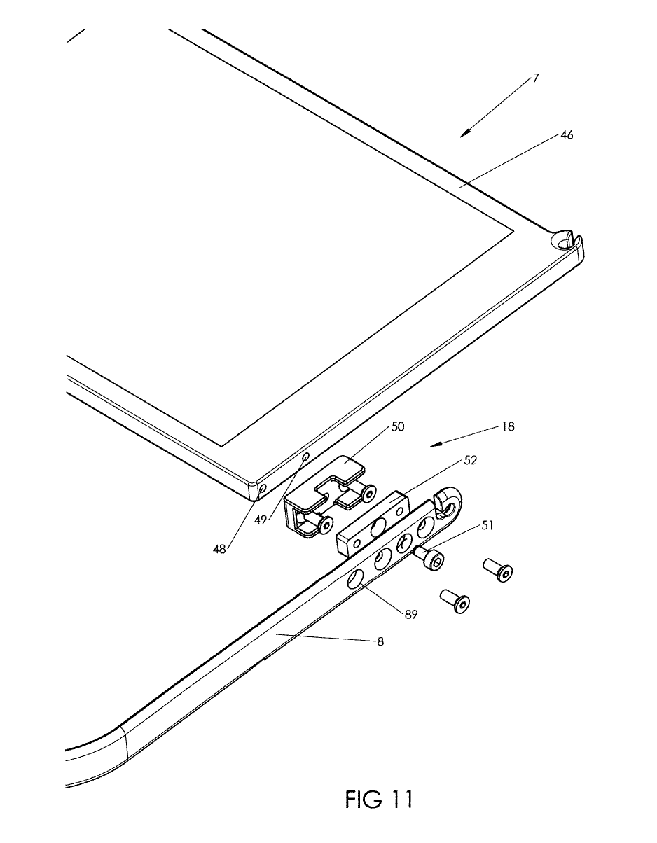

FIG. 11 is an exploded view of FIG. 10 showing details of how swingarm 8 might attach to tablet housing 46 by affixing keyway boss 50 to threaded mounting holes 48, 49. As described in the “342” application, each swingarm lock is comprised of an inwardly biased key 52 affixed to swingarm 8 and which engages into keyway boss 50 and is rotatable about pivot pin 51.

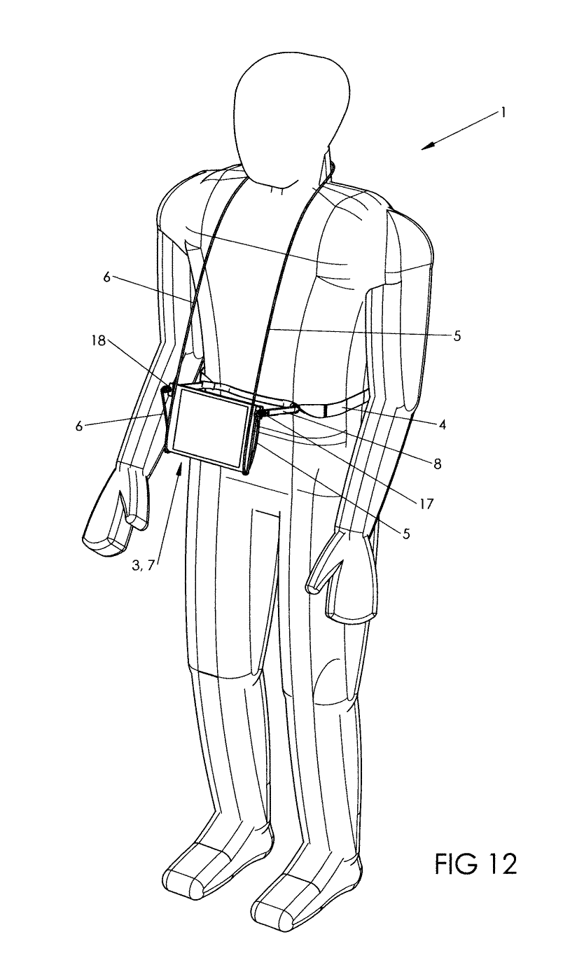

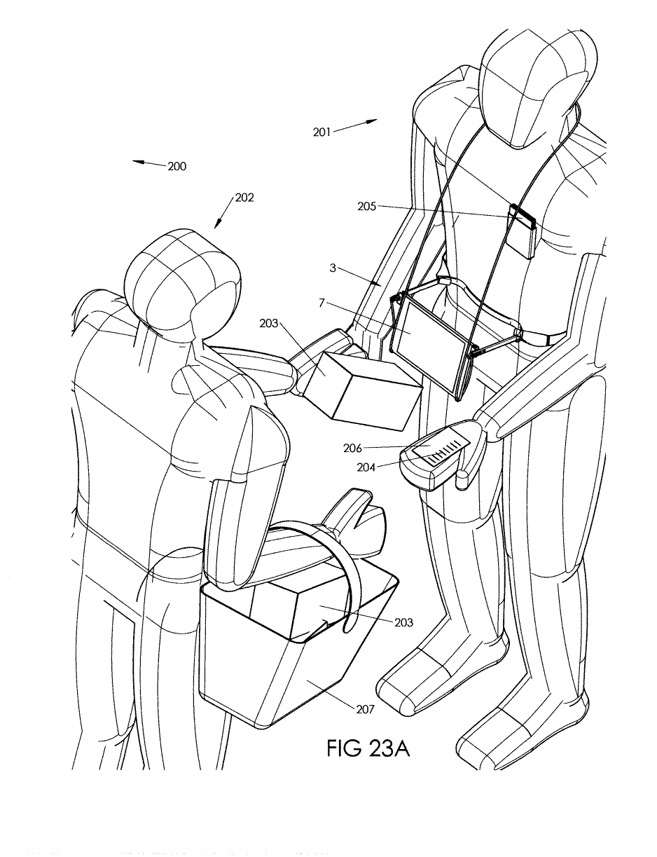

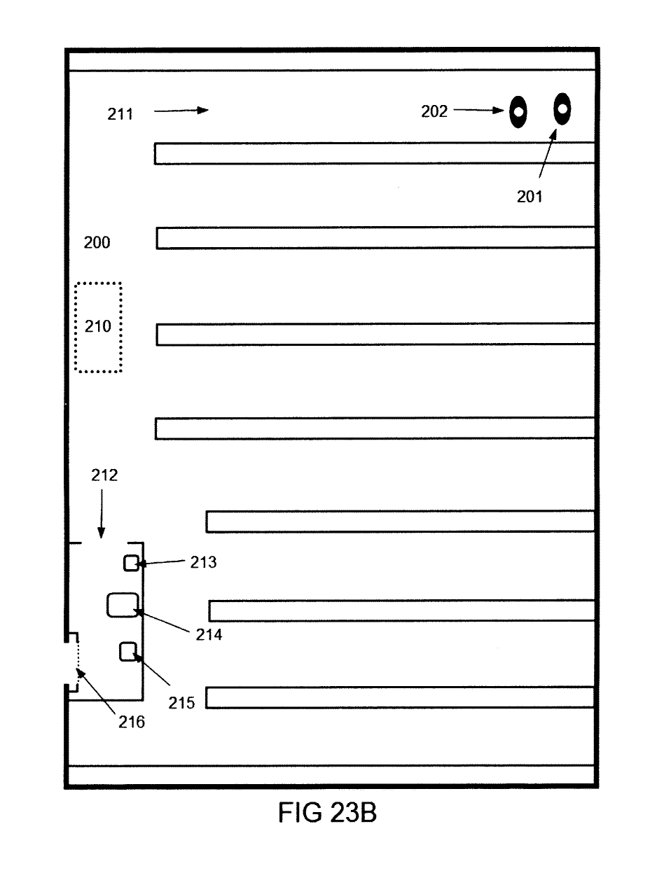

FIG. 12 illustrates how the computer support 3 is manipulated to reconfigure it between the deployed position of FIG. 5 and its storage position of FIG. 13. User 1 first releases rotational locks 17 and 18 by pulling outwards against the inwardly biased, elastically-sprung swingarm 8 and then lifts upwards on its forward, hinged portion to cause relative rotation of computer 7 as shown. Both swingarm and computer will rotate through 180 degrees to nest and lock into each other in the fully-folded storage position when the spreading of the swingarms 8 is relaxed. In this configuration the bridge portion of the swingarm 8 need not be shifted in its position on the user's torso. Users may alternately elect to release the swingarm sides to lock the computer at the 90 degree “desktop stand” position as shown. Locking into this partially-folded configuration is useful for sharing displayed information with other people while the user is walking about (see FIG. 23A).

FIG. 13 illustrates the completed rotation of swingarm 8 into the locked storage configuration. Note that waist strap 4 secures the swingarm 8 to the user's torso, thereby preventing unbalanced forces caused by cords 5 and 6 from quickly rotating the assembly back through 180 degrees so it hangs vertically. Wearing waist strap 4 constrains that unstable rotation, thereby storing energy which enables the user to very quickly reverse the process. Releasing the swingarm locks 17, 18 allows gravity to drive both swingarm and computer back into the operational configuration of FIG. 5. Note that since cords 5, 6 are anchored to the stub extensions of swingarm 8, the cords will through their respective fairleads during this transition manoeuvre. Note also that the stored orientation of computer 7 is facing opposite that of the prior art configuration shown in FIG. 2. The back of computer 7 is pressed against the user's torso and since the computer is often smooth and slippery, adhesive friction pads (not illustrated) may be affixed to it to prevent the computer from sliding into a skewed orientation while being transported.

Note also that in both the configuration of FIG. 13 and the configuration of FIG. 2, computer 7 is held against the user's torso such that environmental sensors (e,g: cameras or scanning distance-rangers) located on either its front or rear surface will be carried hands-free and forward-facing as user 1 moves about. This computer carrying configuration thereby enables computer 7 to engage in background computing activities such as video recording or real-time 3D awareness of the user's environment while computer 7 is not deployed and being used in its configuration of FIG. 1 or FIG. 4.

FIG. 14A illustrates a variant of the invention. Instead of passing cords 5 and 6 through fairleads and affixing then to swingarm 8, said cords simply terminate at left and right anchor points 55, 56, located near the outer front corners of computer 57. Since the load is always carried on an outer extremity of the device, this computer support variant lacks the balanced loading inherent to the configurations shown above. When folded for carrying, the neckstrap also interferes with the closed swingarm so this version of the carrier is less desirable but nevertheless possible. A further disadvantage of securing cords 5 and 6 permanently to the front corners of computer 57 is that their severe offset from the swingarm 8 inhibits the user from twisting and securing the computer into portrait orientation as described above.

Referring back to FIG. 9A: moulded fairleads 41, 42 may be re-configured and used as the cord-anchor points 55, 56 shown in FIG. 14A. To effect this repurposing, cords 5, 6 are detached from swingarm 8 and a knot formed in their ends to prevent them from pulling back through fairleads 41, 42, thereby effectively transforming said fairleads into anchor points 55, 56. The inclusion of said cord-attachment anchor points 55, 56 on backplate 40 enables retrofitting this variant of the invention to existing computers.

FIG. 14B shows detail of how the variant of FIG. 14A may be purpose-built to provide only anchor points 55, 56 for attaching neckstrap cords 5, 6. Note that said anchor points may lack the fairlead gaps cord-gaps 44, 45 of FIG. 9A and that swingarm 8 lacks cord attachment means.

FIG. 14C shows the support 3 for a portable computer 7 of FIG. 14B when configured for shoulder carrying.

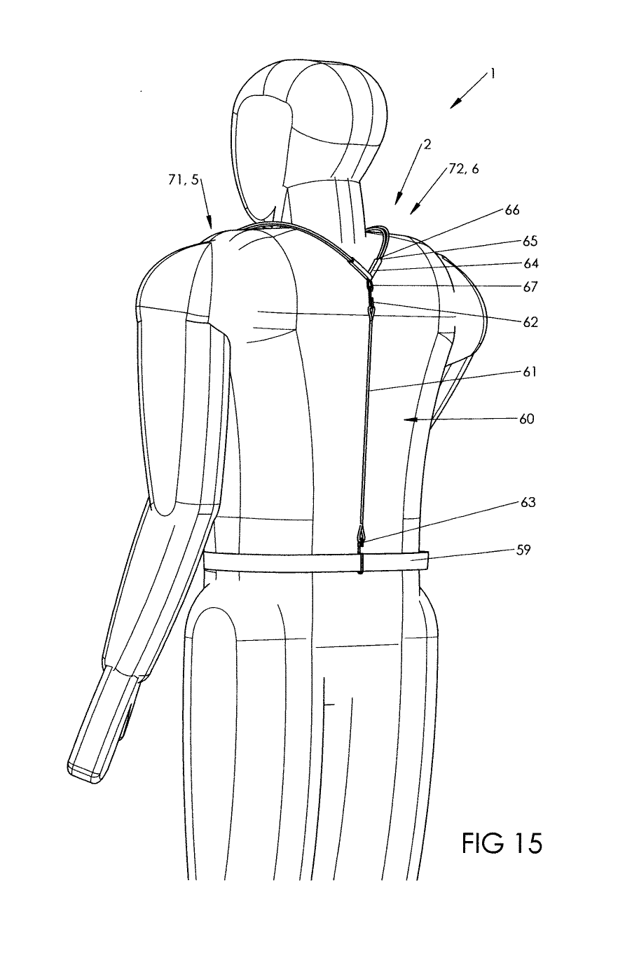

FIG. 15 illustrates a means for reducing user fatigue caused by pressure that neckstrap sleeve 64 exerts onto the back of the user's neck. As described in the “342” application, neckstrap assembly 2 includes sleeve 64, said sleeve having dual cord-channels 65, 66 which isolate cords 5 and 6 as they slide in opposite directions in response to neckstrap length adjusters 71, 72 being actuated (adjusters 71, 72 are visible on FIG. 1 and described in the “342” application). To reduce neck irritation by sleeve 64, user 1 may deploy relief-strap 60, which has its upper end 62 hooked onto neckstrap sleeve 64 and the lower hooked end onto the user's belt 59, the neckstrap sleeve 64 is pulled down and away from the user's neck. Length adjustment means (not illustrated) may be typically provided at one or both of the hooks so that neckstrap sleeve 64 can be pulled slightly down the user's back to relieve neck irritation. Attachment loop 67 may be provided near the mid-point of sleeve 64 to facilitate centered engagement of hook 62. Pulling down on sleeve 64 causes it to form a “V” shape which spreads cords 5, 6 as cord 61 is shortened. This V-shaped deformation causes weight to be divided and transferred onto the user's shoulders where irritation is less likely to be a problem.

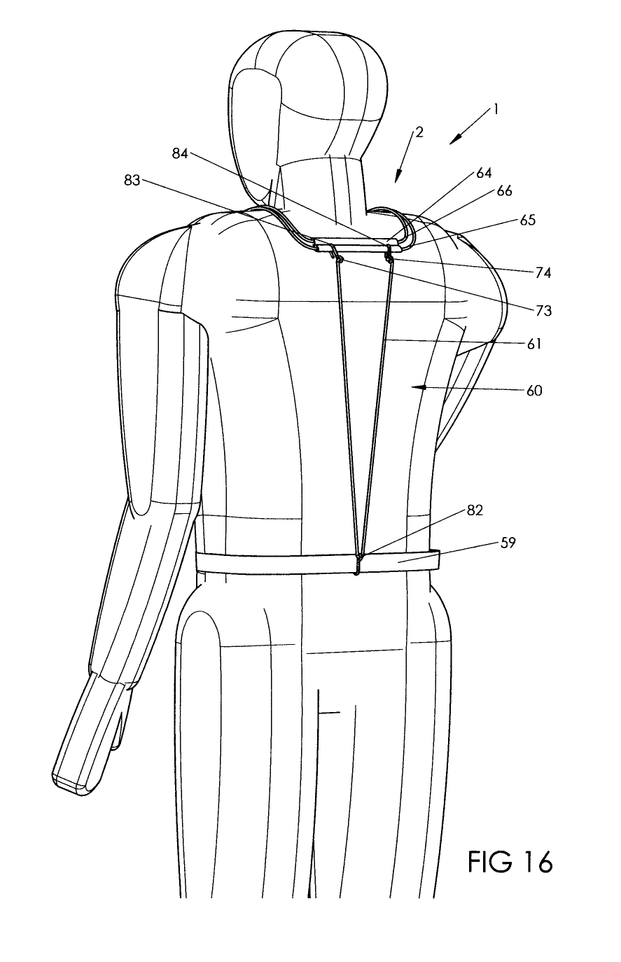

FIG. 16A illustrates an alternate embodiment of the neck pressure relief strap 60. Strap 60 comprises a length of cord 61 to which hooks 73, 74 are affixed at either end. Length adjustment means are typically provided at one or both of said hook locations (not illustrated), thereby enabling user 1 to adjust the cord's effective overall length. Hooks 73, 74 are engageble through holes 83, 84 formed near the ends of sleeve 64. Middle belt-hook 82 is slideably affixed along cord 61 such that the user my engage it onto their belt 59, thereby pulling down equally onto the left and right sides of neckstrap sleeve 64 to give improved weight distribution onto the user's shoulders.

Hooks 73, 74 may be used for detachably affixing the two ends of cord 61 near the left and right ends of neckstrap sleeve 64 however other fixation means are suitable. For example: sleeve 64 may be sewn using fabric having a “loop” finish as described below. If sleeve 64 has this loop surface finish then suitable Velcro™ hook patches affixed to both ends of cord 61 may be used to affix or detach pressure relief strap 60.

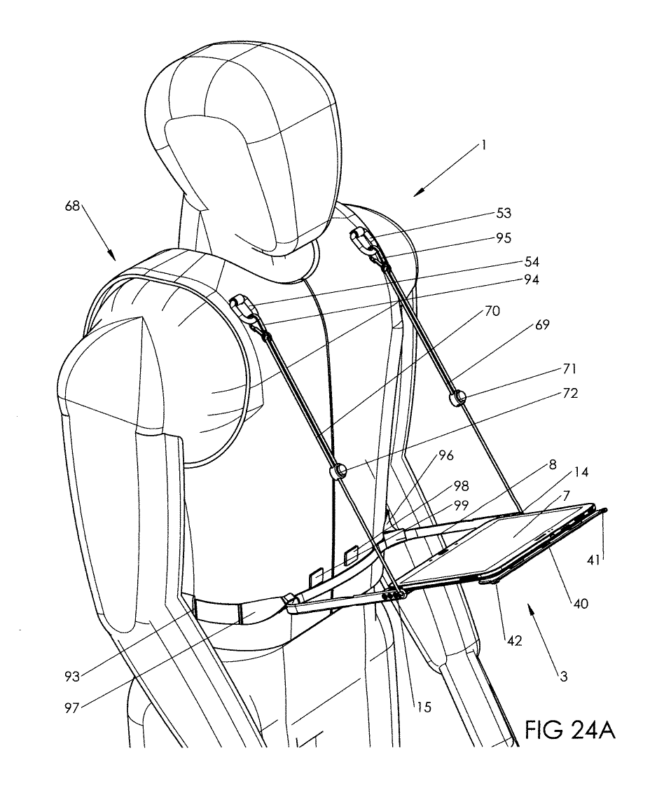

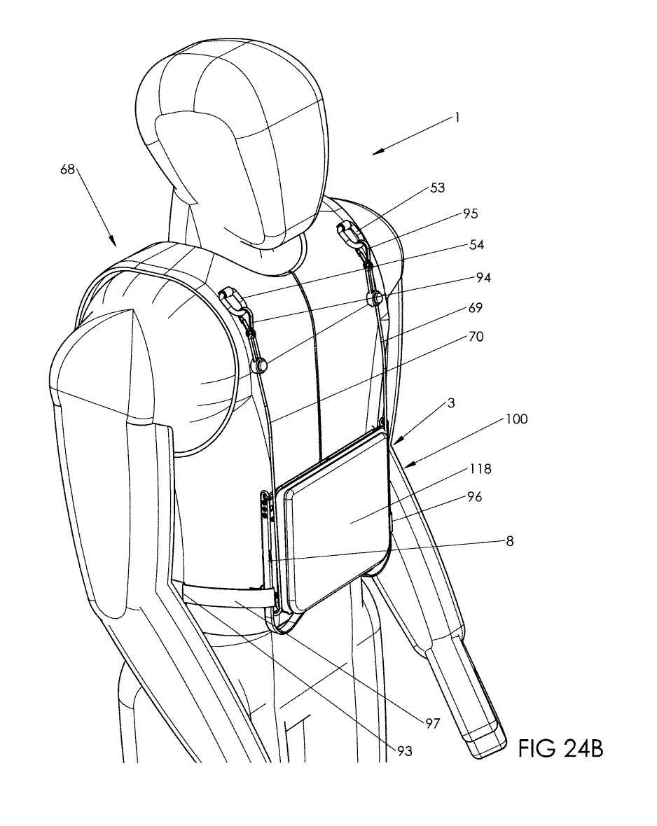

Note that various snaps and buckle fittings used for common sewing tasks are also suitable for detachably affixing pressure-relief strap 60 to neckstrap sleeve 64 such that its left and right ends can be pulled down the user's back as shown. Other means for reducing neck pressure are shown in FIG. 24A and FIG. 24B.

Note also that end-hooks 73, 74 need not be affixed inboard of the left and right ends of sleeve 64 as shown. In a preferred configuration (not illustrated), hooks 73, 74 are each engaged over the left and right cord portions (5, 6) immediately adjacent their respective sleeve channel openings 65, 66. Sleeve 64 is constructed of sufficiently stiff fabric that it acts as a brace between hooks 73, 74 that spaces them apart to form the “V” shape of pull-down strap 60. In this preferred configuration, hooks 73, 74 may be “snap hooks”, such as those commonly used to secure a dog's leash, thereby enabling the user to positively clip each end of adjustable length cord 61 around both cords of neckstrap 2. Alternatively, hooks 73 and 74 may be open hooks each having an aperture sized for a frictional fit over cords 5 and 6, thereby preventing inadvertent disengagement while fitting the pressure relief strap for use. When cord 61 is tensioned, hooks 73, 74 slide flush again the left and right ends of sleeve 64 and pull it uniformly away from the user's neck while transferring weight onto the user's shoulders.

When user 1 wishes to reconfigure their computer support 3 into the transportation mode shown in FIG. 20A, they disengage hook 82 from their belt 59 and sling neckstrap 2 around onto one shoulder. While being carried in this shoulderbag configuration, relief strap 60 can be conveniently stored by disengaging either snap-hook 73 or 74 from around the two cords 5 and 6 and then re-engaging it around either cord 5 or cord 6, thereby enabling the length of the cord 61 to hang neatly alongside cord 5 or cord 6 (the choice of cord depending on whether the user has slung the neckstrap onto their left or right shoulder).

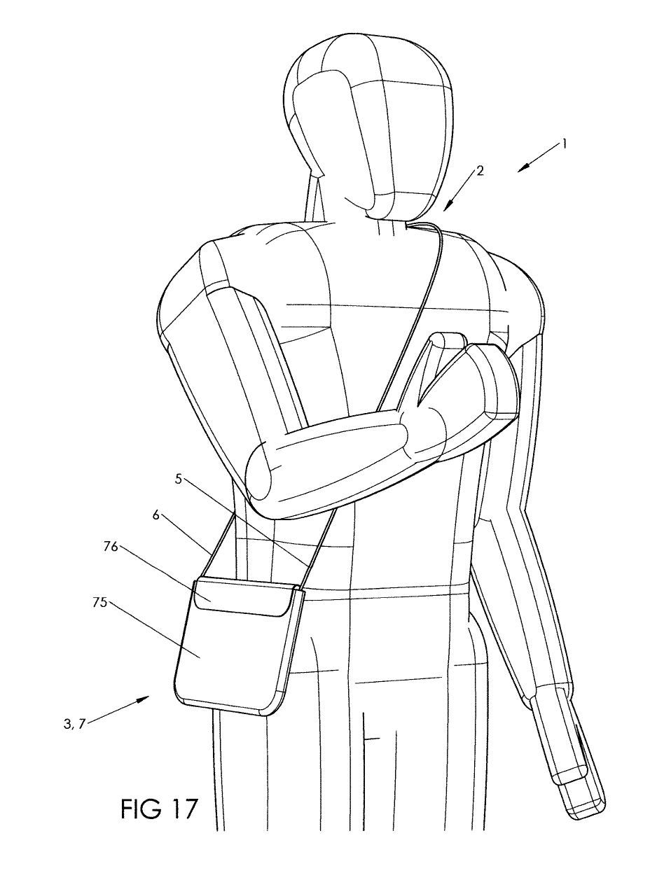

FIG. 17 illustrates a multi-functional protective bag or protective sleeve 75 used for transporting and protecting computer 7 and which gives the overall appearance and utility of a conventional shoulderbag. Protective bag 75 has a fastenable closure flap 76 that enables the user to slide the bag up and over the folded computer and computer support (7, 3) and secure it for transport by closing flap 76. User 1 can then wear it as they might a purse or messenger bag using neckstrap 2 as a shoulderstrap. To configure the computer support for carrying inside bag 75, cords 5, 6 are first disengaged from their respective fairleads and swingarm 8 is then rotated and locked as described in the “342” application. Bag 75 may be advantageously sewn from fabric or neoprene material having a plush “loop” finish that enables any Velcro™ hook surface to adhere to it.

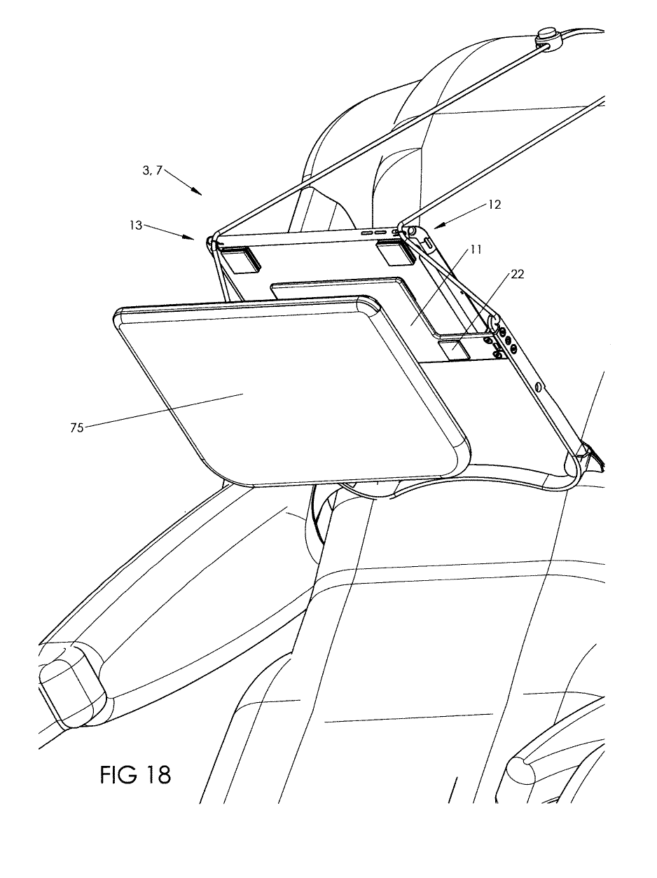

FIG. 18 illustrates how having a loop finish on bag 75 facilitates transporting it while computer 7 is being used. Velcro™ hook patches 22 on backplate 11 and Velcro™ hook patches on left and right detachable fairlead modules 12 and 13 provide four attachment points for gripping either side of bag 75 to provide a convenient means of carrying it while computer 7 is in use.

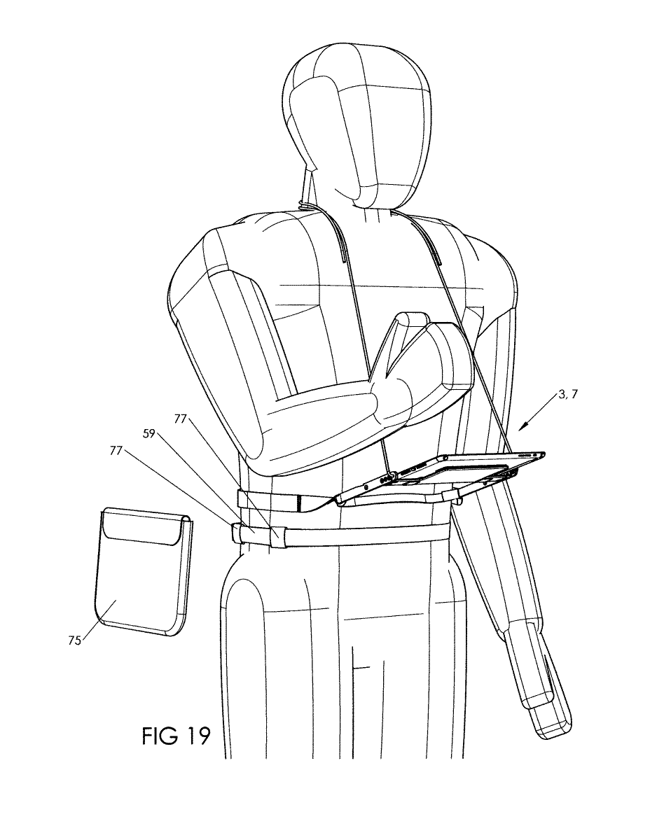

FIG. 19 illustrates another way that a loop finish on bag 75 facilitates transporting said bag while computer 7 is being used. One or more belt loops 77 formed of Velcro are engaged over the user's belt 59, thereby enabling bag 75 to be used as a convenient attachment means for carrying the bag until it is needed again. A benefit of this bag transportation means is that while affixed to the user's belt it serves as a pocket for carrying sundry items while computer 7 is being used.

Velcro belt loops 77 are shown on the same side of the user's waist for storing bag 75 however they may also be positioned on opposite sides and used for storing elastic waist strap 4 while it's not attached to the swingarm of computer support 3. When Velcro loops 77 are used in this strap-storage mode (not illustrated) the two Velcro ends of the elastic waist strap are temporarily affixed to Velcro loops 77 so the waist strap is conveniently stored over top of the user's belt 59.

FIG. 20A illustrates how having a Velcro™ loop finish on bag 75 enables extra cargo carrying capacity to be added to the “shoulderbag” as needed. One or more auxiliary cargo modules 78 may be adhered to the surface of bag 75 using Velcro™ hook patches 22. Each module 78 may carry sundry items such as sunglasses, battery-charger, the user's lunch etc. Alternatively, adhesive Velcro™ hook patches may be applied directly to sundry items such as; keys, small tools, a smartphone etc; whereupon they can be adhered directly to the outer surface of bag 75 (not illustrated). Decorative trimmings may also be adhered to the bag, thereby enabling the user to give their wearable computer a more fashionable appearance. Note that various fabrics may be used to provide a suitable surface on bag 75 for adhering auxiliary cargo module 78 or other items as described above. Neoprene with an engineered plush loop finish is an excellent choice however velvet, velour and felt can also be used to create attractive and functional implementation of this embodiment of the multi-functional protective bag.

Note also that shoulder-carrying the computer as shown prevents the user from operating its touchscreen however this problem can be mitigated by wearing a duplex headset (not illustrated). Wearing a wireless headless (coupled to appropriate “Voice Recognition” and “Text To Speech” software) enables the mobile user to temporarily substitute the headset's Auditory/Vocal User Interface for the touchscreen's Visual/Tactile User Interface and thereby maintain useful interaction with the computer while perambulating as shown.

FIG. 20B illustrates an alternative to the protective bag or sleeve shown in FIG. 17 that includes the capability to carry a cargo module and adds a sunshade function that helps mobile users operate computer 7 in bright viewing conditions. Folded sleeve 100 is comprised of a thin, stiff sheet of material 101 such as polypropylene or polycarbonate. Sheet 101 is formed with a complex perimeter shape as shown having internal scores that serve as plastic hinges to form distinct foldable panels. Bottom panel 102 has the general perimeter shape of computer 7 and backplate 40, and is selectably affixed thereto using a plurality of upper Velcro™ loop patches 109 (typically using four patches as shown to match corresponding hook patches on support 3 and computer 7). Velcro is one convenient means for detachably affixing bottom panel 102 to the bottom of support 3 however other means may be used. For example: if the moulded backplate 40 of FIG. 9A is being used, various male/female attachment fixtures may be moulded into the backplate and bottom panel 102 to perform the same function as the Velcro™ patches 109. The use of magnets instead of Velcro™ or male/female clip fixtures is also an attractive means for securing any of the panels shown in FIG. 20B.

Foldable edge panel 103 connects back panel 102 to top panel 104 to enable the top panel 104 to be swung and affixed over the screen of computer 7 (see FIG. 20D). Left and right edge panels 113 and 114 join top panel 104 through plastic hinges to left and right attachment panels 105, 106. The plastic hinges allow such attachment panels 105, 106 to be folded for support of the top panel 104 as a sunshade. And such attachment panels 105, 106 can be folded the other way to be affixed to bottom panel 102 in various usage modes.

To effect the usage modes shown in FIG. 20E and FIG. 20G, bottom panel 102 includes left and right Velcro™ loop patches 108, 111 for mating with Velcro™ hook patches 110, 112 affixed to left and right closing panels 105, 106. One or more Velcro™ loop patches 107 may be affixed to top panel 104 to enable fixation of cargo modules as shown in FIGS. 20 F and 20G. One or more camera apertures may be provided on bottom panel 102 to enable full operation of computer 7. Left and right closing panels 105, 106 include one or more cord fixation slots 116, 117 for engagement onto cords 5, 6.

Note that while Velcro™ loop and hook patches are well suited to act as attachment means for affixing said panels, other common panel-fixation means are acceptable. For example: common clothing fixtures such as mechanical snaps, magnetic clasps and even zippers might be substituted within the scope of the invention.

FIG. 20C illustrates the protective sleeve of FIG. 20B when configured to act as a sunshade. Edge panel 103, top panel 104 as well as left and right side panels 106, 107 have been rotated such that engagement slots 116, 117 can be affixed onto cords 5 and 6, thereby supporting top panel 104 at an angle that effectively shades the display portion of computer 7 when used in bright viewing conditions.

Note that for best screen viewing in bright conditions, the user must first adjust the angle of their computer 7 by rotating it forward until their own reflection has just disappeared off the bottom of the computer's glossy touchscreen. The dihedral angle of top panel 104 with respect to the touchscreen is then adjusted using slots 116, 117, which provide a length of travel for such purpose, until the user's sightline to the top of the touchscreen becomes clear. If panels 105, 106 are sufficiently stiff then a single cord-gripping slot 105, 106 may suffice to enable adequate height adjustment of the sunshade panel 104. Multiple slots 105, 106 of varying length may also be employed to effect a wider range of angular adjustment.

The lines of reduced strength or scores used to provide plastic hinges of edge panels 113, 114 should have sufficient stiffness to keep such panels 113, 114 somewhat aligned with panels 105, 106 while providing support for panel 104. Note also that since the user's hands have free side access to computer 7 in the described configuration, some ambient light may still be able to enter beneath the sunshade and diminish screen contrast. To mitigate this viewing problem, an accessory fabric curtain (not illustrated) may be affixed to the Velcro strips located on the upper surface of panel 104. Such a curtain can be shaped to hang past the left and right sides of computer 7 and thereby further improve screen visibility in bright viewing conditions. In another variant of such a curtain (not illustrated), its fabric is cut large enough that the user can drape it over their head for complete privacy and optimal screen contrast.

Note also that by enlarging and changing the shape of left and right edge panels 113, 114 (not illustrated), left and right closing panels 105, 106 can be moved down and oriented for folding onto the bottom of panel 102, thereby eliminating the need for support of top cover 104 by tensioned cords 5, 6. This configuration of the protective sleeve can only be used as a sunshade in stationary applications where the user supports the shaded computer 7 on their lap or on a table.

FIG. 20D illustrates the folded sleeve 100 of FIG. 20B while configured to cover the touchscreen of computer 7. Left panels 105, 113 have been fully folded with panel 105 secured to bottom panel 102 by Velcro™ patches 111, 112. Similarly, right panels 114 and 106 have been fully folded with panel 106 secured to bottom panel 102 by Velcro™ patches 108, 110 (see FIG. 20G). This allows all such panels to lie substantially flush with the surface of the computer.

FIG. 20E illustrates the folded sleeve 100 of FIG. 20B while configured for storage while the user is mobile and using computer 7. Panels 103, 104, 114, 106 105 and 113 have all been swung through 180 degrees to lie against the bottom panel 102. Velcro™ patches 108, 110 secure the right side of panel 104 spaced below bottom panel 102. Similarly, Velcro™ patches 111, 112 secure the left side of panel 104 in its transport configuration.

FIG. 20F illustrates the folded sleeve of FIG. 20B configured for use with a cargo module 118. Velcro™ loop strips 107 affixed to panel 104 enable corresponding Velcro™ hook patches on the back of cargo module 118 to be adhered to panel 104, thereby providing the same user function as that shown in FIG. 20A. Module 118 may be made of any fabric suitable for making a purse, messenger bag or similar satchel. Provided that it presents suitably positioned Velcro™ patches, it can be affixed to cover 100 to provide a useful and attractive means of carrying computer 7 as well as small sundry items normally carried in a purse or similar luggage.

Referring back to FIG. 20C: note that cargo module 118 may serve another purpose. It can be attached onto panel 104 such that it overhangs the panel towards the user; thereby increasing the panel's effectiveness as a sunshade.

FIG. 20G is a view of the improved support for a portable computer after cargo module 118 has been affixed to panel 104 of protective sleeve 100. Note that if the cargo module is not too bulky it can be retained in the gap between panels 102 and 104 shown in FIG. 20E after panel 104 has been fully secured in its storage configuration.

If the user requires a larger cargo module than 118 then virtually any container can be adapted with Velcro™ hook patches to affix over panel 104. For example: an existing handbag or shaving kit could be modified with adhesive Velcro™ hook patches and affixed over panel 104 to provide whatever level of style and/or utility that the user desires.

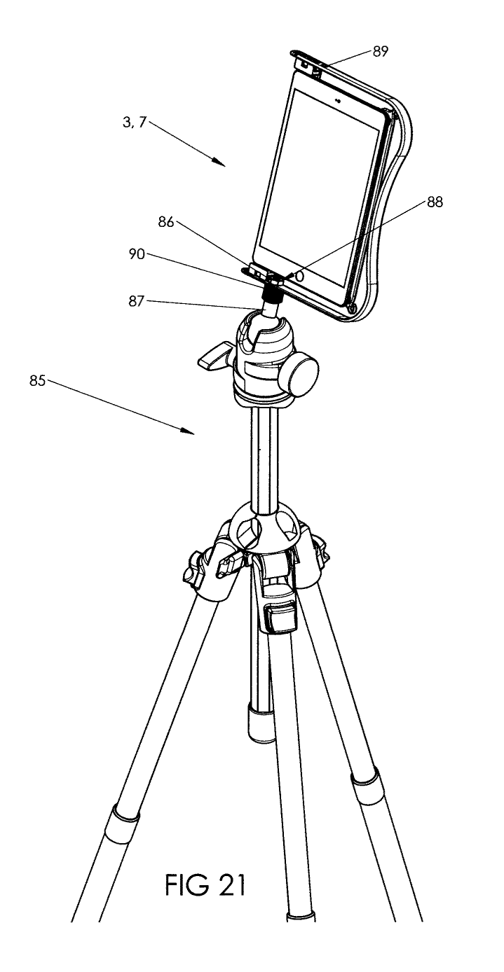

FIG. 21 illustrates an embodiment of the portable computer support 3 which includes means for supporting computer 7 on a standard camera tripod 85. Such tripods typically include a camera-fixation-fixture 87 having a ¼-20 thread. U-shaped swingarm 8 includes left and right mount-holes 88, 89, (two being optional, one sufficient) through which tripod mount thread adaptor 90 can be affixed using a standard nut as shown. Once tightened onto one of the sidearms of swingarm 8, adaptor 90 presents a suitable threaded hole for affixing support 3 and computer 7 as shown. Holes 88, 89 may be formed close to the swingarm's locking mechanism as shown for best structural rigidity. Alternatively, holes 88, 89 may be located further along the arms so as to be located more nearly in alignment with the assembly's center of gravity.

FIG. 22A illustrates a telescopically extendible swingarm 8, 91 that enables more effective use of the combination “Keyboard-Cover” implemented on Microsoft's Surface™ tablet. That style of computer 7 differs from the conventional “clamshell” configuration of the laptop computer shown in FIG. 3 in that its keyboard portion 24 and the screen portion 23 are not friction-hinged together in a manner that enables the screen portion to support itself. Other manufacturers offer similar add-on keyboards that effectively convert their touchscreen tablets into laptop equivalents.

In order to accommodate and carry this “Microsoft Surface™” style of computer, the present invention includes an embodiment that affixes backplate 11 to the back of screen portion 23 in the same manner as a conventional tablet style of computer (see FIG. 9). Keyboard portion 24 is hinged to screen portion 23 such that it may be swung forward to close over touchscreen portion 23 or swung open towards user 1 where it is supported as shown by the bridge-portion of swingarm 8. Since ergonomic typing requires that the keyboard portion 24 be spaced away from user 1, telescopic swingarm extender 91 is added to the standard swingarm structure described above. A plurality of engagement holes 91 may be formed into the left and right sides of U-shaped swingarm 8, thereby enabling corresponding protrusions formed on the inside of similarly shaped swingarm-extender 91 to lock to swingarm 8 at various distances. Other telescoping means for moveably nesting swingarm-extender 91 to swingarm 8 are well known.

The Microsoft Surface™ computer shown in FIG. 22A can be reconfigured for convenient transport by first closing portion 24 over the screen of portion 23 and then collapsing telescoping extender 91 such that it nests onto the curve of swingarm 8, whereupon the portable computer support 3 is further reconfigured as described above for shoulder-carrying it as shown in FIG. 17.

FIG. 22B is a lower view of FIG. 22A showing how the bridge portion of swingarm 8 provides support for the keyboard portion 24 of computer 7. The actuation of telescopic swingarm-extender 91 is also clarified.

FIG. 22C illustrates the embodiment of FIG. 22A when reconfigured for shoulder-carrying as shown in FIG. 17

FIG. 22D illustrates an alternate embodiment of the folding protective sleeve 100 shown in FIG. 20B. This embodiment of the protective sleeve includes a physical keyboard, thereby enabling a conventional tablet computer 7 to operate in a configuration similar to that of the Microsoft Surface™ when it is supported on a tabletop or else be worn in the mobile configuration shown in FIG. 22A.

Folding sleeve 100 includes a full set of “qwerty” typing keys 120 that are formed onto the inner side of it top panel 104. Keys 120 may be of the membrane style to minimize the thickness of panel 104 or else of the traveling button style that provides a better tactile feel for typists but results in a thicker panel. Wireless technology such as Bluetooth™ can be used to transmit keystroke data to computer 7 and any batteries or associated electronic components may be housed within a suitably thickened panel 103.

To use keyboard 120 on desktop 119, the user first disengages locks 17, 18 and repositions swingarm 8 into its desktop stand mode, as described in the '342 application. The use of a “cruciform keyway” enables this alternate configuration. The reconfigured tablet 7 and support 3 are placed on desktop 119 and to reduce desktop clutter, its neckstrap may be removed as shown. Panels 103, 104, 105, 106, 113 and 114 are then unfolded to lie flat for use as shown.

Note that computer 7 may be a full-sized touchscreen tablet such as the Samsung Galaxy Tab 3 10.1™ shown. If so, the width of panel 104 will be sufficient for implementing a standard-width keyboard 120. However, if smaller tablets such as the iPad mini are used then the narrower width of panel 102 may not permit an ergonomically efficient key layout. In such cases, left and right panels 105, 106, 113, 114 may be reshaped somewhat and equipped with additional qwerty keys to complete a full-width keyboard. Since many small tablet computers can interface to large desktop monitors, this ability to integrate a full-sized keyboard into folding sleeve 100 enables a small tablet computer to fulfill a wider range of mobility and office productivity tasks.

Note that this keyboard configuration requires that bottom panel 102 be disengaged from backplate 40 and turned 180 degrees so that when reengaged, edge panel 103 is located adjacent to the computer edge that is furthest way from swingarm 8. This enables simultaneous deployment of both the desktop stand 8 and the desktop keyboard 120.

FIG. 22E shows the desktop productivity configuration of protective sleeve 100 FIG. 22D when reconfigured into the same mobility configuration shown in FIG. 22A. The bridge portion of swingarm 8 supports keyboard 120 and swingarm extender 91 spaces it away from user 1 for good typing ergonomics.

FIG. 23A illustrates a further improvement to the support for a portable computer which accessorizes it for increased utility when being used by a Sales Associates 201 working inside a large retail store 200 (see floor plan in FIG. 23B). This use of a tablet computer to help sell products in a retail environment is an application often referred to as MPOS (“Mobile Point Of Sale”).

MPOS Sales Associate 201 (referred to below as “Associate”) is shown in the process of serving Shopping Customer 202 (referred to below as “Customer”). Associate 201 is wearing computer support 3 in the operative mode shown in FIG. 12, which facilitates using computer 7 to help Customer select merchandise that best meets their requirements. Computer 7 is locked into its vertical display mode, thereby enabling Associate to easily share information on its display with Customers. Note that computer 7 is connected wirelessly to the Internet as well as to the store's secure database 210 (which is described below and shown schematically on FIG. 23B). Computer 7 includes a camera and related software that enables a barcode on any item to be automatically decoded by placing it within the camera's field of view. Equipped with these database and scanning capabilities, Associate scans barcoded item 203 to wirelessly transmit and receive product data or customer data to and from database 210.

At any time during their sales interaction, Associate 201 can rotate computer 7 up into its horizontal usage orientation to perform database searches that reflect the shopping goals being described by Customer 202. Search results can be quickly shared with Customer by allowing computer 7 to drop back into the more vertical display orientation shown. This interaction permits Associate to rapidly provide useful information. Customer 202 can view images of products that meet their search criteria, see prices and technical specifications, see pictures showing various colour or size options, watch demonstration videos of products being considered for purchase as well as learn about inventory status and delivery options for particular products.

This enhanced mobile interaction with Customer 202 also gives Associate 201 the opportunity to alert Customer to upcoming price promotions and possibly recruit them into a points program or get their email address for inclusion in a prize draw or similar promotion; all of which helps establish and maintain customer loyalty.

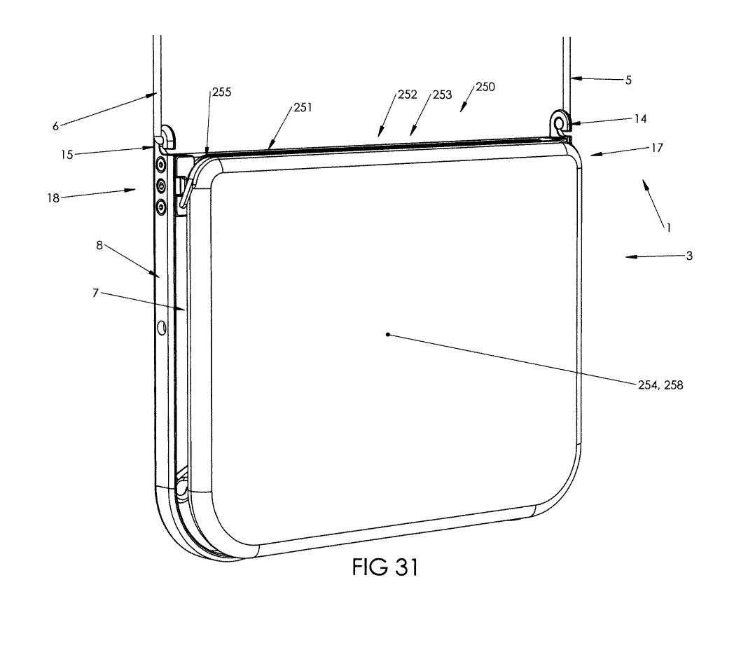

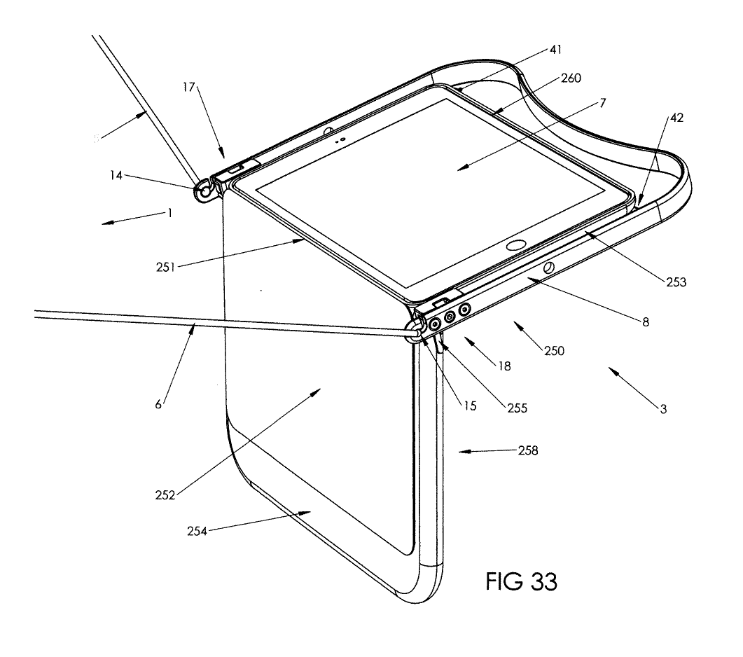

At any time during their interaction, Associate can rotate computer 7 up as described above for FIG. 13 to securely store it against their stomach, thereby liberating both their hands for sales-related manual tasks such as rummaging through stock in a storeroom to find a desired item, demonstrating a product, helping the Customer try on or use an item of apparel or any other manual task that might help the Customer decide to make a purchase. Alternatively, the computer support 3 can be configured and worn in its less conspicuous shoulderbag mode shown in FIG. 31 and FIG. 33.

If and when Customer 202 commits to purchasing an item 203 then instead of directing Customer to take their desired item somewhere else in the store 200 to complete the purchase with a cashier or at a self-serve checkout device, Associate can reach into their pocket and take one of a series of cards in card deck 205. Each of these pre-printed cards is a “Transaction Token” 206 that resembles a typical business card but that serves as a physical basis for managing all of the financial and security operations needed for Associate to complete their business transaction and free Customer to quickly exit the store. The algorithmic steps needed to complete this process are listed further below.

Each pre-printed Transaction Token 206 includes a unique linear barcode 204 (or a unique 2-dimensional “QR” code). Associate initiates Customer's financial transaction on the spot by scanning the unique barcode 204 printed on Transaction Token 206 using computer 7 and then gives the scanned card to Customer 202, informing them that the card will permit them to quickly pass through security when leaving the store.

Each pre-printed barcode represents a corresponding coded element in a computer-generated list of valid new transaction codes stored on database 210. Each time an Associate uses a new code to initiate a transaction with a new customer, that code is deleted from the list of valid transaction numbers so that it cannot be reused. Scanning a new Transaction Token wirelessly triggers creation of a corresponding unique “Transaction Record” in database 210 which is linked to the unique paper Token 206 now in Customer's possession. The digital Transaction Record in database 210 is subsequently used to accumulate and contain all the relevant data elements about to be collected to complete the transaction and is used to follow the algorithmic steps listed further below.

Customer is shown holding a shopping basket 207, which was picked up as they entered store 200 for the purpose of carrying their purchases. They might also have chosen to push a wheeled shopping cart or to pick up a plastic bag to carry their purchases while moving about. For uniformity and clarity the term “Shopping Cart” is used below to describe all three types of store-supplied carrying devices subject to use by Customer 202. The weight of each of said “Shopping Carts” must be accurately known in order for the proposed shopping algorithm to be reliable. If the manufacturing tolerances of shopping carts are such that there is excellent weight uniformity within each shopping cart group (bags, baskets and wheeled carts) then the generic weight for each “cart” group can be used in the process (quite valid for lightweight plastic bags but less reliable for heavy wheeled carts). Ideally, a very precise weight is entered into the algorithm so each individual Shopping Cart 207 may include a barcode (not shown) that can be scanned to link each transaction to that Cart's particular weight (which has been accurately pre-determined and stored in database 210 together with said barcode). Some incoming shoppers will elect to hand-carry their purchases and in such cases Associate simply sets a flag in database 210 to indicate that the weight of Customer's Shopping Cart is zero.

Algorithm for the “Weight-Controlled Mobile Point Of Sale” process used to improve the utility of computer support 3:

Associate initializes a new instance of the Mobile Point Of Sale purchase process by scanning a new unique and valid barcode 204 printed on a new “Transaction Token” card 206 taken from the series of cards 205. This physical Transaction Token 206 is then given to Customer with instructions on how to use it when exiting the store's security gate 216 shown in FIG. 23B. A corresponding “Transaction Record” is opened in database 210.

Customer's Shopping Cart barcode is scanned (if present) or its weight is determined and entered into database 210 by Associate identifying the type of standard Shopping Cart being used. The Cart's precise weight then becomes part of the newly created Transaction Record. If Customer is hand-holding their purchase then Associate simply activates a software button on Computer 7 to set the Transaction Record's “Cart Weight” variable to zero.

Customer (or Associate) holds the first desired purchase item 203 in front of computer 7 so that its barcode is scanned into database 210.

Database 210 looks up all data elements relevant to selling item 203 and copies them into the Transaction Token's corresponding Transaction Record. Such data include: the precise pre-determined weight of the item being purchased (including its packaging), its price per unit, the number of units being purchased, and the product's textual description. If Associate is working on commission then their employee ID may be included for separate payroll processing purposes (not described here).

Transaction Record variables “Total_Price” and “Total_Weight” are initialized with the price and weight of Customer's first purchased item 206.

Customer places first item 206 into their Shopping Cart 207 and, if additional items are being purchased, steps #3, #4 and #5 are repeated until there are no more items to put in the cart. As each new item is added to the cart, the Transaction Record variable “Total_Price” is incremented to reflect actual total price (including tax and any other supplementary charges). The Transaction Record variable “Total_Weight” is also incremented to accurately reflect the current total weight of the goods being purchased.

If store 200 sells bulk items such as food that Customer 202 self-serves and purchases according to weight then Associate 201 will not be able to complete the transaction for that item because weight and price have yet to be determined and added to the running totals. In such cases, Associate only determines the un-weighed item's product code alone, either by scanning the barcode on its packaging (e.g. a code or a sticker on oranges) or by querying the store database 210 based on its description (e.g. “Mandarin Oranges”). The incomplete Item Record is logged into the Transaction Record in database 210 together with a flag indicating that this particular item still requires its weight to be determined in order to determine its price and thereby be able to complete the transaction.

After all purchase items have been entered, Customer gives Associate a suitable electronic payment card to set up database 210 for completion of the sale such as a credit card or debit card. If a credit card requiring a signature is presented then Associate takes appropriate actions which may include swiping Customer's card on a suitable Bluetooth card reader and/or presenting the screen of computer 7 for signing. Electronic payment cards using NFC (Near Field Communications) or other technology may also be used. As soon as payment has been cleared electronically, an “Items_Paid” flag is set in Customer's Transaction Record indicating that they are free to leave the premises of Store 200, subject to the semi-automated finalization of the transaction and the security check; both carried out at the store's exit area 212 (see FIG. 23B).

Customer then proceeds unescorted to the store's automated transaction validation and controlled exit area 212. Associate is now free to serve other customers.

Upon entering exit area 212, Customer 202 holds their Transaction Token 206 in front of scanner 213. The unique barcode 204 printed on the card is read and transmitted to database 210, which first determines if the token card has a valid barcode on it (i.e.: it's a code that's in its table of unused transaction codes and not a Transaction Token that is being re-used fraudulently).

If the Transaction Token is valid (i.e. its barcode is still present in the list) then all of the purchased items data contained in its Transaction Record are examined digitally to see if any of the items still need to be weighed in order to put variables “Total_Price” and “Total_Weight” up to date. If any are present then database 210 will instruct Customer to weigh those items on weigh scale 214. For example: a computerized voice annunciation might speak the words: “Please places your bag of mandarin oranges on the weigh scale”. After an appropriate series of instructions and Customer actions “Total_Price” and “Total_Weight” are up to date and Customer's pre-entered financial data is automatically processed electronically.

As soon as the Transaction Record is complete and all the goods are paid for, database 210 initiates printing of Customer's itemized receipt on printer 215.

Customer is then instructed to place all of their purchased items onto weigh scale 214 for a final security check. To facilitate this step, weigh scale 214 typically has an upper and a lower weighing surface: its upper weighing surface being at a convenient height for Customer to place their shopping basket, shopping bag or hand-held items. A ground-level weighing surface enables Customer to roll their wheeled shopping cart onto it for weight verification.

Once the total weight of Customer's Shopping Cart has been accurately measured by weigh scale 214, database 210 determines if Customer is authorized to exit the store with their purchased items. To do effect this security verification, the value of the Total_Weight in the Transaction Record is compared to the measured weight of the purchased goods about to exit the store (i.e.: the actual weight measured on weigh scale 214 minus the known “Cart_Weight” value of Customer's Shopping Cart). If the measured and computed values agree within a few grams then there's a high probability that Customer has not engaged in any fraudulent manipulation of the contents of their Shopping Cart.

If the shopping cart weigh scale test in step #14 fails then a store employee is summoned to verify the contents of Customer's shopping cart against the printed receipt which printer 215 has just produced and then take appropriate action.

If the shopping cart weight test in step #14 is passed then Customer is instructed to take their receipt and exit the store via controlled exit gate 216. Exit gate includes a sensor to detect the physical passing of Customer 202 through the exit. Other sensors such as RFID sensors may also be used to insure no merchandise has been hidden on Customer's person.

Once Customer has been cleared through the security check and then physically passed through the exit 216, database 210 deletes the barcode 204 printed on Customer's Transaction Token 206 from the stored table of valid codes, thereby insuring it cannot be reused.

FIG. 23B is the floor plan of a retail store 200 shown in FIG. 23A. Associate 201 is dealing with Customer 202 at a location in one of the stores plurality of aisles 211 containing a large plurality of items for sale 203. Database 210 is running on a computer located either within store 200 or at a remote network location. Database 210 is connected wirelessly to computer 7 being worn by Associate 201 and any other mobile Store Associates working on the premises as well as to all electronic peripherals associated with controlled exit area 212.

Note that the “Mobile Point Of Sale” system described above for FIG. 23A has three variants that do not require Associate to give Customer 202 physical custody of printed a Transaction Token 206 but that can still provide a similar or even greater degree of customer convenience, store automation and store security.

Some Customers 202 will enter store 200 carrying their own small tablet computer similar to the larger computer 7 that's shown being worn by Associate 201. These “smartphone” devices are easily capable of displaying the same unique barcode graphic displayed on printed Transaction Token 206. Therefore, in this variant of the sales process; Associate and Customer still carry out their interaction and preamble to the sale using associate's computer 7 and support 3 to help Customer find the best solution to their needs (as described above for FIG. 23A). However, when Customer finally commits to making a purchase, instead of scanning and dispensing a pre-printed Transaction Token 206, Associate first offers to help Customer install a specialized copy of the same software running on computer 7 onto Customer's own “smartphone” (not illustrated) which will then display the barcode 204 needed to pass through security and exit the store. Once this new software has been installed on Customer's device and then initialized (by setting up a new Customer account), Associate instructs Customer how to digitally display the same Transaction Token graphic that would otherwise be printed onto physical card 206. Once this new step is done, steps #2 to #17 of the sales and security algorithm described above can continue unchanged.

One advantage of this variant is that it fosters personal interaction between Associate and Customer, thereby enabling Associate's sales expertise and personal charm to affect Customer's willingness to commit to a purchase. Another advantage is that it facilitates installation of the software needed to perform the even more automated variants #2 and #3 below.

A second variant of the process described above for FIG. 23A is simply to replace the store's sales force of mobile Sales Associates carrying computer 7 as shown in FIG. 23A with a plurality of stationary computers located throughout store 200. In this variant, instead of finding and engaging with an unoccupied Sales Associate 201, experienced customers who know how to use the software can take their purchases to one of many computers 7 affixed to store kiosks where they can self-serve all aspects of the process described above.

The advantage of this variant is that it saves labour costs by relying on customers to serve themselves (however the lack of personal attention from Sales Associates may result in lost sales).

A third variant of the weight-controlled security algorithm and sales process described above for FIG. 23A is to enable and allow customers to use their own smartphone or tablet device to automatically perform all of the process tasks. Upon entering the store, the copy of software on their device is recognized by the local computer network as belonging to a registered and fully qualified customer (a login password is required). Once logged in they can proceed anywhere in store 200 to scan and collect items 203 into their shopping cart 207 without any interaction with a store employee. When their shopping tasks are finished they can quickly exit the store; simply by performing steps #10 to #17 described above.

Note that all 4 versions of the weight-controlled security algorithm described above can be implemented and co-exist in the same store 200, thereby enabling all customers to select the level of service automation they feel comfortable with. A fifth way to augment the robustness of the system described above is to provide traditional cashiers and line-ups to transact with customers and control exit security.

FIG. 24A illustrates an alternate embodiment of the body-harness shown in FIG. 16 (which comprises neckstrap 2 and neck pressure relief strap 60). That 2-part harness relieves neck pressure by transferring weight onto the user's shoulders and lower torso however other wearable means may be used to improve comfort. FIG. 24A shows user 1 wearing a torso-fitting garment 68 that includes left and right cord attachment fittings, such as D-rings 53, 54. The b-rings are sewn onto the upper front shoulder portions of garment 68 and configured to mate with left and right snap-hook fittings 94, 95, each of said snap-hooks being affixed to the upper end of adjustable length support cords 69, 70. The lower ends of cords 69, 70 engage onto computer support 3, either at points 14, 15 on swingarm 8 or else at fairleads 41, 42 on backplate 40 or at anchor points located near the forward corners of computer 7. When affixed to computer support 3, garment 68 is effectively transformed into a neck-pressure relief device that is functionally equivalent to the body-harness 2, 60 shown in FIG. 16.

Note that garment 68 can take various forms and styles: a sleeved coat, a shirt or else a sleeveless vest as shown. Garment 68 may also take the form of a common “Utility Apron” (not illustrated) having left and right straps that suspend the apron from the user's shoulders by criss-crossing down their back and securing to the lower apron edges at waist level where a belt cinches the apron onto the users torso; thereby forming a robust shoulder harness to which D-Rings 53, 54 are affixed to the front at shoulder level. Vent apertures and/or cargo pockets may be provided on the apron for cooling, utility or styling purposes. The Utility Apron may also include Velcro patches 98, 99 to facilitate storage of waist strap 4 as described below.

To prevent support 3 and computer 7 from swinging away from the user during vigorous activity, an elastic waist strap similar to that shown in FIG. 1 is typically provided and incorporated into the lower back and side portions of garment 68, said strap being stored inside the garment's waist strap sleeve 93. Left and right strap portions 96, 97 exit both sides of said sleeve, where they can be engaged onto swingarm 8, to stabilize the computer with respect to the user during vigorous activity. Velcro™ patches 98, 99 may be sewn onto the lower front portion of garment 68 as shown, thereby enabling user 1 to neatly secure the loose ends of straps 96, 97 to the garment while they are not being used (by reusing one or both of the Velcro™ patches that secure each waist strap end around swingarm 8 as previously described).

Waist strap sleeve 93 is formed around the back of garment 68 for storage of waist strap portions 96, 97. For neat appearance said sleeve may be continuous around the back of garment 68 so that the waist strap is hidden from view. Alternatively, said sleeve 93 may be comprised of a plurality of belt loops spaced around the back of garment 68 to retain the strap in place when its left and right portions 96, 97 are not tensioned together. If continuous, a central opening at the back of said sleeve may be provided to facilitate tension adjustments using said strap's central length adjustment buckle. Left and right waist strap portions 96, 97 may be affixed inside sleeve 93 to become a permanent part of garment 68. More typically, the joined waist strap portions are removable from within said sleeve, thereby enabling it to be used on computer support 3, independent of garment 68, and stored there by spooling it around swingarm 8.

Similarly, Garment 68 can be used independent of the apparatus 3, 7. While serving solely as wearing apparel (jacket, shirt, vest), the garment's stored elastic waist strap 96, 97 can be used to cinch the garment about the user's waist for better appearance or to prevent cold air from entering. To effect this independent usage of said waist strap, user 1 adjusts the length of the strap such that affixing its ends 96, 97 onto the storage patches 98, 99 will tension the garment to provide the desired closeness of fit. Alternatively; waist strap ends 96, 97 may be affixed through belt buckle end fixtures (not illustrated) thereby converting the motion-control strap of FIG. 1 into a functional component of garment 68.

FIG. 24B is a view of FIG. 24A after the computer support 3 has been reconfigured for mobile storage of computer 7. For illustrative purposes, support cords 69, 70 have been lengthened using adjusters 71, 72 and rerouted through fairleads 41, 42 to enable better side access to the computer's touchscreen. Also for illustrative purposes, the folded protective sleeve 100 of FIG. 20B has been added in its configuration that covers the forward-facing touchscreen of computer 7. Also added is the modular cargo bag 118 of FIG. 20F.

Note that the direct cord routing of FIG. 24A will cause computer 7 to be stored in the opposite direction from the configuration of FIG. 24B (in which the stored touchscreen faces onto the user's torso as shown in FIG. 2). Also note that when the direct cord routing is used in conjunction with the large backplate 40 of FIG. 9A, it forms a robust, forward-facing plate that can act as armor in harsh user environments such as on construction sites or in military applications. User 1 can therefore reconfigure cords 69, 70 between their two routing modes to optimize the computer support for either easy side access to the computer's touchscreen or for maximum protection of the computer in harsh environments.

Note also that users will occasionally want to remove or open the front of garment 68 without first having to fully disengage computer support 3 from said garment. To configure an asymmetric wearing mode that meets that requirement, user 1 first detaches the waist belt ends 96, 97 from swingarm 8 and stores them neatly onto Velcro™ patches 98, 99. With swingarm 8 folded into its storage position, one of the two computer support cords 69, 70 is detached from its shoulder fixation 53, 54, thereby allowing the folded apparatus 7, 3 to hang diagonally from one of its four corners (not illustrated).

By shortening cord 69 or cord 70, the apparatus 3, 7 will swing and hang conveniently under the user's left or right arm in an attitude and position similar to that of a handgun when stored in a concealed shoulder-holster. To prevent the disengaged cord 69 or 70 from dangling, the end of the unused cord may be clipped onto the one that's being used to suspend the computer. To facilitate best positioning of the apparatus under the user's armpit, a short accessory strap (not illustrated) may be provided that engages onto a D-ring at its upper end and onto the highest portion of swingarm 8 at its lower end. To prevent the diagonally hanging computer from swinging about during vigorous activity, left and right hold-down straps (not illustrated) may be sewn to the front of garment 68 at locations where they can be looped around the lowest-hanging portion of swingarm 8 to fully secure the suspended apparatus to the user.

Garment 68 with integrated computer support 3 and computer 7 is a torso-worn wearable computer that has performance advantages over a wrist-worn computer (“smartwatch”) or a face-worn computer (“Google Glass™”). Garment 68 is well suited for use by uniformed groups such as: police, military, construction-workers, sales staff or other user-groups prone to wearing uniforms. For individuals desiring a hands-free, wearable computing device, the fashion industry can provide versions of garments 68 that carry their touchscreen computer in an attractive and versatile manner.

FIG. 25A illustrates a multi-mode carrying strap 220 that improves the versatility and ease of use of computer support 3 when it is being worn in its mobile usage mode (i.e.: when the support is not being used as a desktop stand). Carrying strap 220 integrates the functions of the neckstrap 2 and the neck pressure relief strap 60 (see FIG. 16) into a single strap that can provide the extreme length adjustability needed to configure the strap into any of three distinct usage modes:

1—A shoulder-harness mode (very long)
2—A side carrying, shoulder strap mode (medium length)
3—A neckstrap mode (short)

FIG. 25A illustrates the carrying strap configured into its shoulder harness mode. Carrying strap 220 is comprised of a single length of cord 221 engaged through belt-hook 224 to form left and right cord portions 222, 223. Belt-hook 224 has a lower hook portion for engagement onto the user's belt 59 and an upper eyelet portion through which cord 221 is slideably engaged, preferably with sufficient friction to maintain hook 224 near the midpoint of cord 221. Left cord portion 222 extends up and over the user's left shoulder, down and through fairlead 41 and back up to terminate at cord-stop fixture 225. Cord-stop 225 is a standard dual-hole, push-button style of fixture commonly used in the apparel industry and is used here to selectably grip onto cord 222, thereby creating left strap-length adjustment loop 228. Similarly, right cord portion 223 reaches over the user's right shoulder to form a right strap-length adjustment loop 229, which adjustably supports the right side of computer 7 at fairlead 42. By adjusting the position of left and right cord-stops 225 and 226 along cords 222, 223, user 1 adjusts the effective overall length of carrying strap 220, thereby adjusting the height and angle of computer 7 as required. Note that the weight of carrying computer 7 is evenly distributed over the user's shoulders and upper torso. Note also that the user's belt 59 anchors the shoulder harness low on the user's torso and that cord tension over the shoulders is balanced front and rear, thereby cancelling shear forces on their skin, thereby insuring long-term wearing comfort, even if computer 7 is quite heavy.

Length adjustment loops 228, 229 can be engaged or disengaged into fairleads 41, 42 by pressing the cords through the close-fitting cord-gaps 43, 44 (see FIG. 9A). This removability enables computer 7 and computer support 3 to be easily reconfigured for desktop use or for hand-holding as described in the “342” application without being encumbered by dangling cords. The removability of carrying strap 220 also enables loops 228, 229 to be transferred onto attachment points 14, 15 on swingarm 8, thereby gaining the improved balance characteristics described in the “342” application. When attached to the swingarm at 14, 15, the apertures through the left and right arms serve as fairleads similar to fairleads 41, 42 (see FIG. 5 for details of how loops 228, 229 pass through close-fitting gaps to engage onto the swingarm's stub extensions without danger of them inadvertently falling off). The left and right fairleads 41, 42 (located on backplate 40) and the left and right fairleads 14, 15 (located on swingarm 8) are all configured to provide low-friction running of cord 221 through their central aperture and their close-fitting engagement/disengagement gaps are configured to enable the user to easily transfer the carrying strap 220 between backplate 40 and swingarm 8.

User 1 will preferably engage belt-hook 224 onto their existing pants belt 59, thereby providing a robust rear anchor point for cord portions 222 and 223. Some users will not be wearing a belt and in such cases they can engage hook 224 onto elastic waist strap 4 instead. In such cases, waist strap 4 will deflect up the user's back (not illustrated) until friction onto their clothing arrests motion (thereby lowering computer 7 in the front). Length adjusters 225, 226 are then actuated to shorten cords 222 and 223 and compensate for the waist strap's elasticity. To maximize the comfort of using waist strap 4 as an anchor point for carrying strap 220, the waist strap's length adjustment buckle 227 is typically located at the user's side rather than centered on their back. Note that in some cases the user might be wearing pants without a belt and is such cases the user may engage belt-hook 224 onto a belt-loop instead of elastic waist strap 4. Note also that users may exploit existing belt loops on the left and right side of their pants to prevent the slackened waist strap from falling to the ground during manoeuvres to transition the computer support between its various operational modes. A secondary benefit of passing waist strap 4 through the user's left and right belt-loops (not illustrated) is that the upward pull on their pants will be more ergonomically distributed onto their lower body. A third benefit of passing elastic waist strap 4 through left and right pants belt-loops is that the loops will constrain upward deflection of the elastic strap and thereby reduce the amount of compensation needed to anchor onto the elastic strap 4 instead of onto the user's (more rigid) belt 59.

To further optimize elastic waist strap 4 for use with computer support 3, its two ends are configured for attachment around swingarm 8 such that they can also be easily attached to each other, thereby forming a continuous belt that stores around the user's waist while not in use (instead of storing the waist strap by spooling it onto the swingarm as previously described). To configure the waist strap ends for attaching to each other without undue stretching, the location of its hook and loop Velcro™ patches are reversed for optimal mating. With reference to FIG. 5, the placement of Velcro™ hook patch 9 and Velcro™ loop patch 10 at the left end of waist strap 4 are positioned opposite to the placement order of their mating patches at the right strap end. This reversed placement order of the spaced apart hook and loop patches at each end enables the user to more easily attach a hook patch to a loop patch and thereby store strap 4 around their waist without undue stretching.

Note that while Velcro™ hook and loop fasteners are specified above for affixing the waist strap ends around swingarm 8, other common apparel fasteners may be used (e.g.: male/female snap fixtures). Also note also that belt-hook 224 is specified as a unitary hook for engaging onto the user's belt however two-part male/female fasteners such as plastic bayonet fixtures may be employed for more effectively prevention of inadvertent disengagement of carrying strap 220 from belt 59. In such cases one part of the male/female connector is looped around the user's belt 59 and worn there when not connected to its mating part (not illustrated).

FIG. 25B illustrates the carrying strap of FIG. 25A when shortened for transporting the computer by slinging it over one shoulder. User 1 has first detached both ends of waist strap 4 from swingarm 8 and stored it for convenient transport in cargo module 118 (described below). Swingarm 8 has been unlocked and rotated into its parked configuration. User 1 has shortened carrying strap 220 by releasing the grip of cord-stops 225, 226 onto cords 222, 223 (by squeezing on the push-buttons of each cord-stop). Once the cord-stops are released, the weight of the computer and its support caused adjustment loops 228, 229 to grow larger as cords 222 and 223 ran through fairleads 41, 42. Since the overall length of carrying strap 220 is inversely proportional to the size of loops 228, 229, simply squeezing the cord-stops while the computer is suspended from left and right cords 222, 223 as automatically shortened carrying strap 220. When carrying strap 220 arrived at the desired length for shoulder carrying, the user simply released both cord-stops to arrest further shortening, whereupon the computer was slung over one shoulder as shown.

Lengthening carrying strap 220 to return it to the configuration of FIG. 25A is the reverse of the procedure just described except that instead of suspending the computer from cord portions 222, 223 and letting gravity grow the size of adjustment loops 228, 229, the user hangs the shortened cord from their neck and lowers cord-stops 225, 226 along cords 222, 223 to shrink the size of adjustment loops 228, 229 and thereby lengthen the strap.

To better illustrate the computer support's versatility and utility as personal luggage, folding protective sleeve 100 and cargo module 118 are also shown (as per FIG. 20G). Note that while this luggage configuration is shown suspended from fairleads 41, 42, the user may also suspend it from the opposite side so that it hangs from the fairleads formed on the swingarm at 14, 15. Fitted cargo module 118 is affixed to Velcro™ loop patches on sleeve 100 however the user may affix other luggage items’ such as an existing purse that has had suitable Velcro™ hook patches affixed to it (not illustrated).

FIG. 25C illustrates the strap of FIG. 25A when shortened to serve as a neckstrap. Note that this shortest, neckstrap configuration is particularly useful for hands-free positioning of the computer while user 1 is lying in bed. Hands-free use of a computer while lying down is particularly useful for slow-paced recreational activities such as watching a video or reading an EBook however virtually any touchscreen activity can be accomplished while lying in bed, provided the computer support is optimally configured.

Note that while the user is lying horizontally (not illustrated), computer 7 and swingarm 8 form a nearly vertical tower that is balanced on their chest. The tension in carrying strap 220 and its attendant neck pressure discomfort are therefore minimal as well (i.e.: there is little reason to configure the shoulder harness configuration of FIG. 25A). Note also that while using the computer in this posture, the user's elbows are constrained against the bed so that the open side-access provided by routing the carrying strap through front fairleads 41, 42 is particularly advantageous. To a lesser extent, this also applies to postures and activities such as lounging on a sofa.

To configure the short neckstrap of FIG. 25C, the shortening procedure is the same as described above for FIG. 25B; the user simply continues shortening the carrying strap until belt-hook 224 arrives immediately adjacent to cord-stop 225 on the left and cord-stop 226 on the right, at which point the strap is configured to its minimum length. This tight group of three fixtures (the belt-hook between two cord-stops) will rest against the back of the user's neck so to prevent discomfort (when the user stands up or when the fixtures are pressed against the user's neck by a pillow), a cushioning sleeve 230 may be provided and fastened over the three fixtures as shown.

Cushioning sleeve 230 may be comprised of a rectangle of resilient fabric closed around carrying strap using a zipper, snaps, a Velcro closure or the like. Alternatively, a closed, hollow, cushioning sleeve 230 may be positioned behind the user's neck as shown by first disengaging a loop end 228 or 229 from any of its possible fairlead locations (41, 42, 14, 15), then sliding the cushioning sleeve over the cords to the desired location, whereupon the detached adjustment loop is reengaged into its fairlead. In yet another embodiment; the cushioning sleeve is comprised of a jacket of foam rubber having a frictional engagement slot formed along one side that can be engaged over cord 221 to cover and cushion the strap as needed.

Note that the same cushioning sleeve 230 used to relieve cord pressure on the back of the user's neck can also be used to relieve cord pressure on their shoulders when wearing a heavy computer for extended periods. Therefore two sleeves 230 may be provided so that the user can deploy one onto each shoulder while the carrying strap is being used in the shoulder harness configuration of FIG. 25A. Similarly, cushioning a sleeve 230 may be deployed onto cord 221 in the configuration of FIG. 25B to improve comfort while using the computer support as personal luggage.

Some users have body proportions that demand a very long cord 221 in order to form the shoulder harness of FIG. 25A. And since for some computer activities (such as watching a video in bed) using a very short neckstrap is desirable; cord 221 may in some circumstances be too long to be shortened into a satisfactory neckstrap. To address that problem, an alternate method of shortening the carrying strap may be employed; one that makes use of all four of the available fairlead attachment points (two on the backplate and two on the swingarm). By spooling excess cord between front and rear fairleads, an optimally-sized neckstrap can be configured to fit all users, regardless of their physiognomy, their posture or their desired computing task.

Referring to FIG. 25C: to configure a short spooled neckstrap, left and right adjustment loops 228, 229 are first shortened to an intermediate length such as that shown in FIG. 25B. Loops 228, 229 are then disengaged from their respective fairlead points 41, 42 on backplate 40 and transferred to their fairlead points 14, 15 on swingarm 8. The doubled cords 222, 223 are then manually re-routed back through fairleads 41, 42 (not illustrated). Fairleads 41, 42 are not typically formed to accept a double thickness of cord however the outer shape of the fairleads serves as a post around which the additional cord can be routed to effectively constrain the carrying strap such that it provides the desired support geometry shown in FIG. 25C. This shortened neckstrap must be manually re-configured each time the user actuates swingarm 8. However, for the leisure applications for which it is ideally suited, taking that extra time to configure carrying strap is not a significant drawback compared to the versatility afforded by having a single strap capable of being configured into the three usage modes described above.

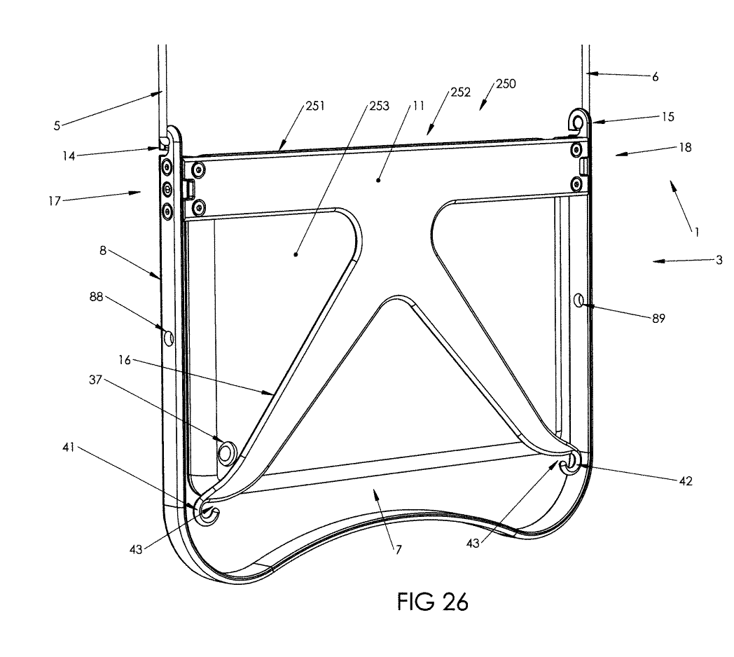

FIG. 26 is the back-side view of an embodiment of computer support 3 that utilizes receiving case 250 to grip tablet computer 7 (not visible). Receiving case 250 fully contains tablet 7 and is affixed to backplate 11, thereby forming an operative assembly with swingarm 8, neckstrap cords 5, 6 and user 1. Receiving case 250 is a commonly available prior art accessory used for hand-holding and protecting tablet computers and is often referred to as a “folio case”. Receiving case 250 is affixed to backplate 11, typically with an adhesive joint 16 that joins the two components into a single hybrid part.

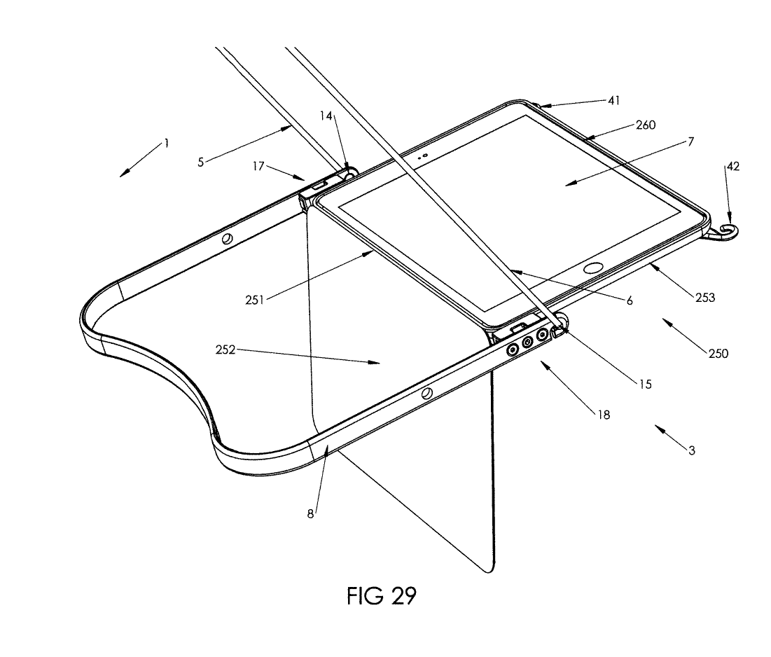

Case 250 is comprised of a rigid rear shell portion 253, which is typically a moulded plastic part. Rear shell portion 253 is rotatably joined to front screen-cover portion 252 (not visible) along hinge 251. Hinge 251 is typically a flexible flap extension of screen-cover portion 252 that wraps around and is bonded to rear shell portion 253. Rear shell portion 253 is typically a plastic injection-molded part that precisely fits onto the back of a particular tablet computer 7. It is typically formed such that a small internal rim overhang deforms to snap over the perimeter of the tablet to grip it (see 260 on FIG. 29).

These types of commercially available snap-on folio cases are fairly easy to fit onto or remove from the tablet. In another embodiment of support 3, tablet 7 and shell portion 253 are more permanently bonded together using an adhesive, screws or specialized fasteners that are only removable by technicians when accessing the tablet for servicing. The resulting monolithic product is a turn-key wearable computing system analogous to the “OEM” embodiments disclosed in the previous “342” PCT application.

In yet another embodiment, backplate 11 is permanently bonded directly to the back of tablet 7 to form a monolithic “OEM” or “turn-key” wearable tablet computing system (very similar to FIG. 9B). This alternate embodiment also includes a hinged screen-cover 252 however, since the rear shell portion 253 is not present, screen-cover 252 is affixed to the computer support 3 along hinge 251 directly to the edge of backplate 11 that joins left and right lock mechanisms 17 and 18. To effect the required hinged fixation while maintaining a clean appearance, the hinge flap portion of screen-cover 252 (not illustrated) is typically sandwiched in between tablet 7 and backplate 11 while bonding the two together. To accommodate the thickness of the hinge-flap portion (not illustrated) while bonding it in between backplate 11 and tablet 7, a suitable recess may be provided in backplate 11 adjacent to hinge 251. Backplate 11 (bonded directly to the back of an OEM tablet computer 7) may be machined from aluminum or similarly sturdy material however to reduce costs it may also be mass produced by injection-moulding it in a high-strength plastic such as glass-filled nylon or polycarbonate.

Note that, while this simplified embodiment of the receiving case lacks a protective rear shell portion, in the event of it being dropped, tablet 7 is nonetheless very well protected by the surrounding swingarm 8, fairleads 41, 42, backplate 11 and screen-cover 252.

Rear shell portion 253 may also include camera-hole 37 if needed to accommodate a particular tablet's rear-facing camera. Swingarm 8 may also include threaded holes 88, 89 for mounting computer support 3 onto a standard camera tripod as shown in FIG. 21. Backplate 11 may be attractively curved as shown to provide a bonding surface onto the back of shell 253 while avoiding obstruction of camera hole 37, as well as providing left and right fairleads 41, 42 and swingarm locking components 17, 18. Neckstrap cords 5, 6 may be selectively re-routed through close-fitting fairlead apertures 43, 44 to provide unobstructed side-access to tablet 7, as shown in FIG. 4, FIG. 9A and FIG. 20E.

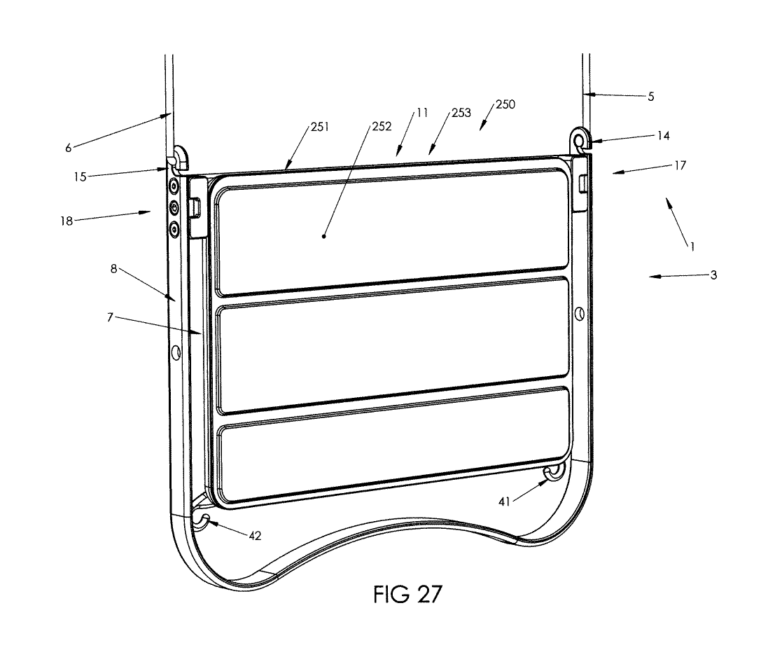

FIG. 27 illustrates the embodiment shown in FIG. 26 but from the opposite side. The rotatable screen-cover portion 252 of hard-shell receiving case 250 is shown closed over tablet computer 7, thereby fully protecting it therein. Receiving case 250 is typically an OEM tablet accessory configured to fit a particular tablet and these products typically include a segmented screen-cover portion 252 similar to the one shown. Segmentation enables the folded cover to act as a triangular tablet-stand when placed on a table, a practice first popularized by Apple's “Smartcover™” product. These screen covers 252 typically include magnets that operate switches within the tablet to automatically turn the computer on or off depending on whether the case 250 is closed or open.

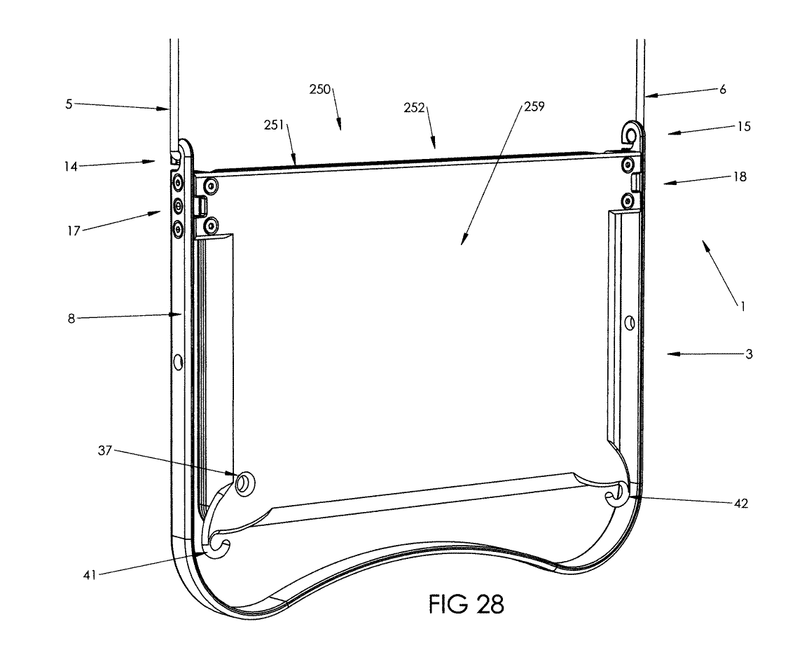

FIG. 28 illustrates an alternate configuration of the receiving case shown in FIG. 26. Integrated rear shell portion 259 is moulded to integrate left and right swingarm locking flanges 17, 18 as well as left and right cord-fairleads 41, 42 into a single moulded part. This integrated embodiment is well-suited for efficient manufacturing of the “turn-key” computing system described above.

FIG. 29 illustrates the embodiment of FIG. 26 and FIG. 27 when its swingarm is in its opened configuration for hands-free mobile use of the tablet computer. Locks 17 and 18 have been disengaged and re-locked once swingarm 8 has been rotated through 180 degrees so that user 1 can wear cords 5 and 6 on the back of their neck while swingarm 8 supports tablet 7 away from their torso. Deformable rim 260 is gripping tablet 7 in receiving case 250 and screen cover 252 has been rotated about hinge 251 to hang vertically and expose the operative surface of tablet 7 for use. If user 1 so desires, cords 5 and 6 may be lengthened and re-routed through fairleads 41 and 42 to improve side-access to tablet 7.

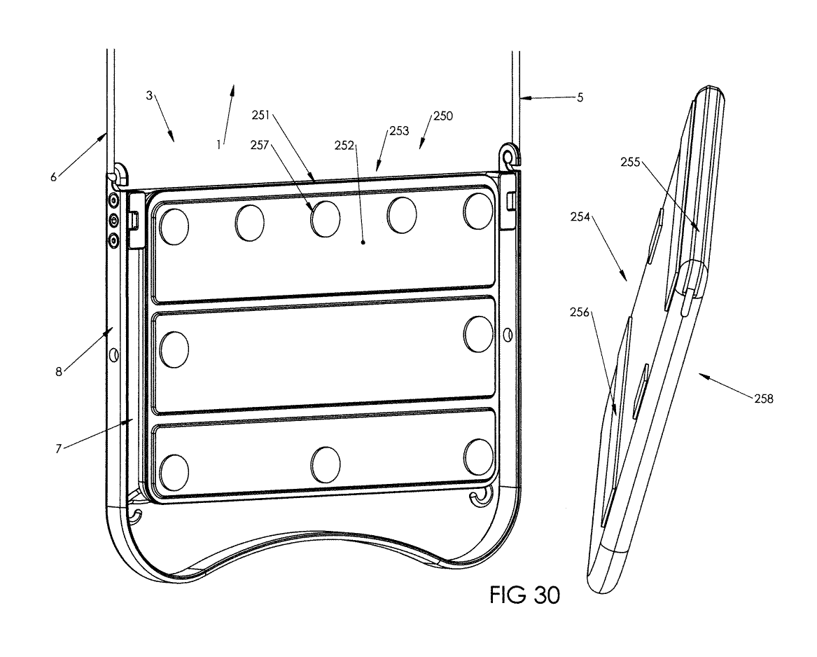

FIG. 30 illustrates fabric cargo pouch 254 that is configured for detachable fixation onto hinged screen-cover 252. Cargo pouch 254 includes a closable upper opening 255 for retaining sundry items therein. The preferred bag closure is a zipper however other bag closures, such a flap with snap fixtures, may be used. The front-facing fabric surface 258 of cargo pouch 254 may include decorative graphics as described in detail further below.

The back surface of cargo pouch 254 includes patches of Velcro™ hook material 256 that are positioned for engagement with corresponding Velcro™ loop material on the surface of screen-cover 252. The surface of the conventional prior-art screen-cover 252 shown in FIG. 27 has been modified by the addition of a plurality of discrete Velcro™ loop patches 257 that are strategically disposed around its perimeter for engagement with corresponding hook patches 256 on the back of cargo pouch 254.

Alternatively, for improved appearance and tactile feel while the bag is detached, the entire surface of screen-cover 252 may be modified by covering it with a single Velcro™ loop patch 257 during its manufacture. Producing this specialized, purpose-built screen-cover is conveniently accomplished while fabricating a specialized screen-cover having a hinge-flap configured for direct bonding into the “turn-key” embodiment described above for FIG. 26.

To facilitate actuation of the swingarm mechanism, the fabric used to form pouch 254 is lightweight and flexible; thereby enabling it to deform easily and pass over the user's fingers as receiving case 250 swings through the swingarm. Note that the positioning of the Velcro™ pouch fixations inboard of swingarm 8 creates a flexible pouch portion that overhangs the edge of receiving case 250, thereby enabling a perimeter portion of the cargo pouch to act as an expansion bellows as sundry small items are added. The flexible overhang portion also enables the user to easily grip the lower portion of the pouch and use it to swing the attached screen-cover 252 away from tablet 7 as needed. Note also that the use of the 3-panel segmented screen-cover enables the attached cargo-pouch 254 to bend as needed so it can pass though swingarm 8.

FIG. 31 illustrates the computer support of FIG. 27 with cargo pouch 254 installed onto receiving case 250, thereby enabling the cargo pouch to be worn in the cross-body “shoulderbag mode” shown in FIG. 17. The perimeter shape of cargo pouch 254 conforms to the outer shape and dimensions of swingarm 8, thereby largely concealing the computer support 3 from view. Concealing the utilitarian mechanism of support 3 behind a shoulderbag enables users to consider their wearable device to be as much a fashion accessory as it is an ergonomic tool.

To enhance its appearance as a fashion accessory, cargo pouch 254 may be sewn from a fabric chosen for its attractive appearance however doing so limits the user's fashion choices to a limited number of fabric designs. Therefore, in its preferred embodiment, front-facing cargo pouch surface 258 has individually customised graphics printed onto it (not illustrated). For example: a high resolution photo of an existing fabric can be printed onto it to simulate a shoulderbag made of that material. Alternatively, users can print their own digital photos onto it to make a personalized fashion statement . . . any attractive photo or graphic obtained online or elsewhere can be used to create the user's desired fashion appearance. The result is infinitely variable fashion based on using a single, cargo pouch design as the printable media.

To enable efficient and cost-effective printing of such digital images onto surface 258, a large plurality of cargo pouches 254 are first mass produced to fit a particular size of computer support 3. Unique images can then be printed onto front-facing printable surface 258 using, for example, the well-known “dye-sublimation” printing process; which enables photorealistic digital images to be transferred onto white polyester fabric using a suitable dye-sub printer, a transfer sheet and a heat press. To obtain optimal print quality, print surface 258 may be temporarily stretched onto a rigid platen (not illustrated) that is inserted inside the pouch during the heat-pressing phase of the printing process. The digital images used to print each unique pouch is managed through an online sales portal that enables customers to either choose a desired shoulderbag appearance from an online catalogue of photos and textile simulations or else upload a personal image from their own computer. Once the customer's desired fashion image has been chosen and formatted, it is printed onto a blank while cargo pouch 254 and mailed to them.

Since desktop dye-sublimation printing equipment is quite inexpensive, production of these customised pouches can be electronically directed to a network of home-based producers through a centralized online sales portal. The website-based sales and production network enables customers to interact visually with their assigned shoulderbag producer. Communicating and collaborating through the internet with a home-based designer/manufacturer enables the customer's desired digital image is correctly enhanced and customised prior to printing. For example: captions or slogans can be added to images that have been digitally manipulated using Photoshop™ or similar software.

Since each cargo pouch 254 is Velcro-mounted onto the user's portable computer support 3, they can be easily swapped to suit different activities and to match the fashion of different outfits in their wardrobe. By taking close-up photos of fabrics used to make their clothing and upload the images to the online sales portal, a series of cargo pouches can be printed that exactly match the fabrics in their wardrobe. This fashion flexibility promotes the purchase of new cargo pouches that reflect each person's evolving fashion needs.

To further customise each cargo pouch 254 to suit a customer's fashion tastes, customer and remote fashion designer/producer can collaborate online to create a physical overlay to the image that is printed onto surface 258. This decorative overlay is typically a glued-on mosaic comprised of small “tiles” of various shapes (including numbers and letters) that are cut from velvet, leather, fishskin or other exotic fabrics. To enable the fashion mosaic to be rapidly designed and fabricated, a variety of mosaic patches are pre-cut and coated on one side with thermoplastic glue. The customer and fashion producer then collaborate to choose and arrange “tiles” into a pleasing design laid out in the same heat-press used for the initial dye-sublimation printing. Use of a real-time video conferencing tool such as Skype™ facilitates the process and helps establish the personal relationship needed to ensure customer satisfaction. Once their fabric mosaic design is laid out in the heat-press in a way that complements exposed imagery printed onto the underlying polyester fabric 258, the overlay is fused onto the substrate by closing the heat-press; thereby melting the thermoplastic glue and joining the upper and lower layers of the design. Additional decorative elements such as feathers, sequins, charms, jewels, etc may be glued or sewed on separately to add relief and variety to the overlay.

In yet another embodiment of this glued-on decorative overlay, the heat-fused mosaic includes strategically located patches of Velcro™ loop material, thereby enabling attachment of suitably configured cargo pouch modules of varying size, style and function. For example, the customer might elect to purchase suitably configured outer pouch modules for carrying items such as sunglasses, coins, battery charger, audio ear buds, etc (see FIG. 20A).

Use of add-on modular cargo units expands the versatility of the computer support. For example: with reference to FIG. 23A, Sales Associate 201 might Velcro a modular business card dispenser onto their cargo pouch for more convenient dispensing of transaction tokens 204. If a separate, wireless barcode scanner is needed to deal with customer 202, then that too could be Velcroed onto surface 258 using a suitably configured cargo pouch, thereby giving faster access to the scanner and better customer service. To further increase the overall utility of cargo pouch 254 in this MPOS application, the retail store's logo and other business graphics might be prominently printed onto the pouch to advertise and promote the store's brand and corporate image. Prominently displaying corporate graphics will also help shoppers to identify Sales Associates in the store, particularly when the device is being side-worn in its conventional-looking shoulderbag mode.

If the Sales Associate 201 is using their tablet for various “BYOD” (“Bring Your Own Device”) applications throughout their work and personal life, then when leaving the store after work they can easily detach their “work-fashion” cargo pouch bearing their employer's business logo and replace it with a different shoulderbag design that's in harmony with their personal sense of fashion.

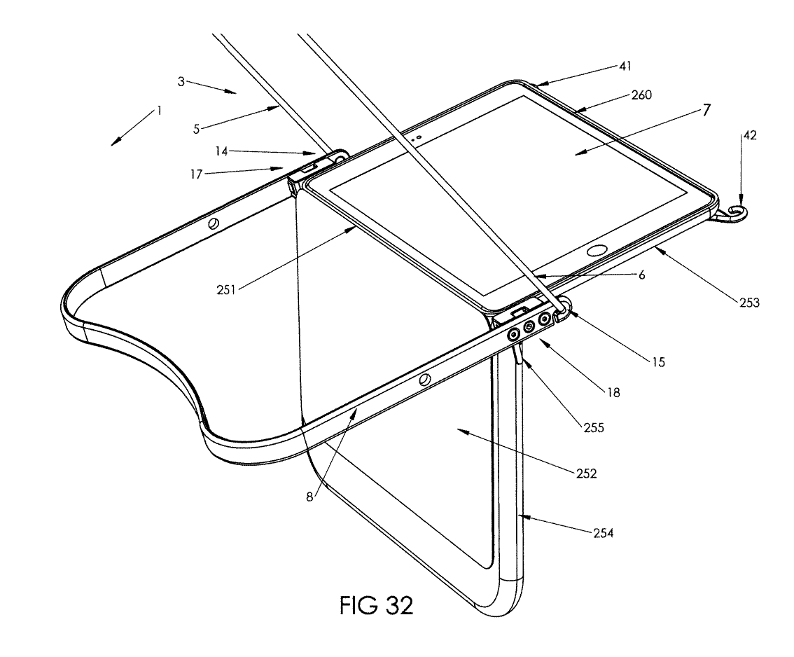

FIG. 32 illustrates the hands-free tablet use configuration shown in FIG. 29 but with a cargo pouch 254 attached to its screen-cover 252. To reconfigure the computer support 3 from its side-worn shoulderbag mode (as in FIG. 17 and FIG. 31) into this front-worn hands-free tablet usage mode (as in FIG. 4), the user first shifts the computer to the front of their body by drawing their right arm back through neckstrap cords 5 and 6. They deploy swingarm 8 as shown and then grip fabric pouch 254 to swing the screen-cover 252 through the swingarm to hang vertically. Depending on the nature and duration of their anticipated tablet use they may also elect to stabilise the tablet using elastic waist-strap 4 (as in FIG. 4) or deploy the pressure-relief strap 60 (as in FIG. 16). Deployment into and out of this “front-wearing mode” is somewhat time-consuming and is therefore generally more appropriate for long-term intensive use of the tablet.

FIG. 33 illustrates an alternate usage configuration that is well-suited for rapid, hand-held deployment of the tablet for short-term use. Usage of this “side-wearing mode” maintains the cross-body neckstrap configuration of FIG. 17 at all times, which greatly speeds up the process of transitioning between the shoulderbag mode of FIG. 31 and this handheld tablet usage mode.

With reference to FIG. 17 and FIG. 31: to transition into the handheld usage mode of FIG. 33, user 1 first reaches back with their right hand and grasps the right side of swingarm 8. They then swing the computer support 3 towards the front of their body while simultaneously using their left hand to grasp the lower portion of cargo pouch 254 and use the loose fabric as a handle to pull the attached screen-cover 252 away from tablet 7. If present, the magnets which are typically embedding near the edge of such screen-covers will automatically turn on the computer and ready its touchscreen for use. The user then swings screen-cover 252 through 270 degrees so it hangs vertically as shown.

Folded swingarm 8 serves as a secure handhold while using tablet 7. When finished with their mobile computing task, the deployment process described above is reversed to reconfigure the handheld tablet back into a side-worn shoulderbag. Note that, since neckstrap 2 remains slung over the user's left shoulder throughout the usage cycle; if at any time the suspended computer support is dropped, gravity will cause it to swing back towards its side-worn shoulderbag position. Note also that the slack left neckstrap cord 5 is directed upwards towards the user's left shoulder while the slack right cord 6 remains more horizontal due to it being routed under their right arm. This neckstrap configuration thereby facilitates touchscreen access for right handed users holding the computer support in their left hand. Left-handed users typically switch sides so that, when in shoulderbag mode, cargo pouch 254 is carried on the left side of their body.

If, while computer support 3 is being handheld as shown in FIG. 33, the user wishes to use the tablet in a hands-free mode but doesn't wish to take the time needed to transition into the front-wearing mode of FIG. 32, they may still use a hands-free variant of the handheld mode described above. To use this “side-worn hands-free mode” (not illustrated) the user first deploys the computer support as shown in FIG. 33. They then deploy the swingarm from its folded position to reconfigure the computer support as shown in FIG. 32. The neckstrap cords 5 and 6 will remain asymmetrically disposed upwards and horizontally as shown in FIG. 33 and the computer will be asymmetric positioned towards the right side of the user's body. This asymmetry will somewhat restrict the ability to use the computer's touchscreen to its full potential. For example, two-handed typing on its virtual keyboard while mobile will be ergonomically sub-optimal and the tablet's asymmetrical positioning towards the right side will cause it to twist somewhat unstably if friction between the swingarm and the user's torso is interrupted.

Notwithstanding those drawbacks, opening the swingarm will permit very rapid deployment into an asymmetric hands-free wearing mode that is still quite adequate for many tasks. For example: hands-free reading of an EBook or casual web browsing while waiting at a bus stop or while in line at a coffee shop are activities that are well-suited to this “asymmetric hands-free” usage mode.

Note also that the weight of the computer is borne by the user's left shoulder and distributed across their back, thereby applying pressure that is considerably more comfortable than when the same pressure is applied onto the back of their neck (as in FIG. 4). This obviates the need to deploy a neck pressure relief strap for long-term wearing comfort (as shown in FIG. 16).

Note also that the tendency for the asymmetrically held tablet to twist can be greatly mitigated by attaching the ends of elastic waist strap 4 to swingarm 8 (as shown in FIG. 4), thereby increasing friction between the computer support 3 and user 1 to stabilize the device during active manoeuvres. Note that the skewing force inherent to this asymmetric wearing mode can be partially counteracted by attaching just one end of waist strap 4 to the side of swingarm 8 opposite to side the user carries the computer support when in its shoulderbag mode of FIG. 31.

### CONCLUSION

The foregoing has constituted a description of specific embodiments showing how the invention may be applied and put into use. These embodiments are only exemplary. The invention in its broadest, and more specific aspects, is further described and defined in the claims which now follow. These claims, and the language used therein, are to be understood in terms of the variants of the invention which have been described. They are not to be restricted to such variants, but are to be read as covering the full scope of the invention as is implicit within the invention and the disclosure that has been provided herein.

1-30. (canceled)

31. A computer support for attachment to a portable computer to be used by a user comprising:
a) a body support member by which the weight of the computer may be carried by the upper body of the user, and
b) a body propping member for positioning the computer outwardly from the torso of the user that includes two movable arms with computer connections for connecting with the computer when present and outer deployable arm ends that are joined by a bridge to form a U-shaped propping member or “swingarm”,
wherein:
i) such arms are deployable from storage positions along the sides of and coplanar with the computer when present to a deployed operating position whereat the respective deployable ends of the arms are positioned for being supported by the torso of the user, at least one of such arms being disengageably fixable at the storage position and at the deployed position by latches to allow locking of the U-shaped propping member in place,
ii) the body support member comprises two neck cord portions that, when the U-shaped propping member is deployed, carry at least a portion of the weight of said computer through corresponding fairleads located proximate to the outer two corners of a computer when present for removeably capturing the two neck cord portions, and
iii) the neck cord portions terminate and are anchored at a point on the computer support along the side edges intermediate the outer and inner edges of the computer when present.

32. A computer support as in claim 31 wherein the neck cord portions terminate and are anchored at such arms.

33. A computer support as in claim 31 comprising one or more mounting holes formed in the swingarms to receive and engage with a camera-fixation coupling on a camera tripod.

34. A computer support as in claim 31 further comprising an elastic waist strap adapted to be stored about the user's waist for attachment to the swingarm.

35. A computer support for attachment to a portable computer to be used by a user comprising:
a) a body support member by which the weight of the computer may be carried by the upper body of the user,
b) a body propping member for positioning the computer outwardly from the torso of the user that includes two movable arms with computer connections for connecting with the computer when present and outer deployable arm ends that are joined by a bridge to form a U-shaped propping member or “swingarm”, and
c) a receiving case with a screen cover hingedly mounted thereon and transversely mounted between the respective swingarms, the cover being positioned to either overlie the computer screen in a closed configuration, or to be rotated to expose the screen,
wherein such arms are deployable from storage positions along the sides of and coplanar with the computer when present to a deployed, operating position whereat the respective deployable ends of the arms are positioned for being supported by the torso of the user, at least one of such arms being disengageably fixable at the deployed position to allow locking of the U-shaped propping member in place,
and wherein the outer surface of the cover carries connectors to serve as attachment means to engage complementary attachment elements on an accessories bag

36. A computer support as in claim 35 in combination with an accessories bag wherein the bag is dimensioned to be detachably fitted onto the hinged screen-cover, extending outwardly to the outer perimeter of the computer support, screening it from view.

37. A computer support as in claim 35 wherein the bag has a front, outer-facing fabric surface which is a printable surface for presenting graphics.

38. A computer support as in claim 35 wherein the bag has a loop fabric finish for engaging with a hook-type fastener.

39. A computer support as in claim 35 wherein the face of the bag opposite the face carrying the connectors includes a patch of loop fastener material for engaging with complementary fastener material affixed to the side of an outer pouch module for attachment of the pouch module to the bag.

40. A computer support as in claim 39 in combination with an outer pouch module.

41. A computer support as in claim 31 in combination with a computer.

42. A computer support as in claim 35 in combination with a computer.

43. A method of using the computer support of claim 31 in both a side-worn computer carrying mode and a front-worn computer usage mode comprising the steps of:
1. side-carrying the closed computer support with its neckstrap over one shoulder as one would carry a shoulderbag, with the contained computer facing away from the user;
2. grasping and shifting the computer support forward to hand-hold it with the computer facing upward and the screen cover swung open for handheld screen usage as needed,
3. unlocking and opening the swingarm through 180 degrees and re-locking it for propping against the user's abdomen;
4. lowering the computer support to tension its neckstrap passing over the user's shoulder, diagonally across their back and under their armpit to support the computer in a hands-free usage mode as needed;
5. lengthening the neckstrap as needed and passing its shoulder-side cord portion through its corresponding fairlead to transfer weight from the cord's anchor point to the forward edge of the computer for more un-encumbered computer access as needed;
6. detaching the shoulder-side end of the elastic waist strap and attaching it to the nearest point of the swingarm to stabilized the frontally-deployed computer support into a “tensegrity” structure as needed during active user motion
7. reversing steps 6 to 1 to reconfigure the computer support into its side-worn carrying configuration when finished using the computer.
